(19) United States
(12) Patent Application Publication
(10) Pub. No.: US 2023/0139986 A1
(43) Pub. Date: May 4, 2023

(54) SYSTEMS AND METHODS FOR INSURANCE APPLICATION PROCESSING

(71) Applicant: STATE FARM MUTUAL AUTOMOBILE INSURANCE COMPANY, BLOOMINGTON, IL (US)

(72) Inventor: Nick Marotta, Phoenix, AZ (US)

(73) Assignee: STATE FARM MUTUAL AUTOMOBILE INSURANCE COMPANY, BLOOMINGTON, IL (US)

(21) Appl. No.: 17/985,946

(22) Filed: Nov. 14, 2022

Related U.S. Application Data
(63) Continuation of application No. 17/980,107, filed on Nov. 3, 2022.
(60) Provisional application No. 63/278,186, filed on Nov. 11, 2021.
(60) Provisional application No. 63/275,712, filed on Nov. 4, 2021.

(51) Int. Cl. G06Q 40/08

(52) U.S. Cl. CPC G06Q 40/08

(57) ABSTRACT

A computer-implemented method and computer system configured to provide automated insurance quotes, insurance policy offers, and issued insurance policy contracts. A quote requester may initiate a quote request by using their mobile device to scan a QR code associated with a product offered for sale by a product offeror during a transaction. The mobile device may automatically generate and transmit a quote request to a computer system of the insurance provider. In response to the quote request, the insurance provider computer system may access a computer system of the product offeror for information about the product and information about the quote requester collected in connection with the transaction. The insurance provider computer system generates a quote-requester specific insurance quote, and transmits the insurance quote to the quote requester's mobile device for their review, modification, or approval.

### CROSS-REFERENCE TO RELATED APPLICATIONS

The present application is a continuation of U.S. patent application Ser. No. 17/980,107, filed Nov. 3, 2022, which claims priority to and the benefit of U.S. Provisional Application No. 63/275,712, filed Nov. 4, 2021, and U.S. Provisional Application No. 63/278,186, filed Nov. 11, 2021, the subject matters of which are expressly incorporated herein by reference in their entirety.

### FIELD

This disclosure generally relates to electronic systems and computer-implemented methods for secure data storage and access. More particularly, the present embodiments include systems and methods to enable secure data storage and access in connection with insurance application processing.

### BACKGROUND

Conventional insurance policy application processing approaches may have a number of drawbacks. For example, they may be inefficient, time consuming, inaccurate and/or untimely. Therefore, there remains a continuing need for technology to enhance insurance policy application processing. Technology that enables insurance policies to be efficiently, accurately and timely processed would be particularly desirable.

### SUMMARY

The present embodiments disclosed herein may include mobile devices operated by users to obtain (i) insurance quotes; (ii) offers to enter into insurance policy contracts; and/or (iii) issued insurance policy contracts in connection with a transactions to purchase goods or services. The present embodiments may include a computer system operated by, or on behalf of, an insurance provider to provide customers or other users with insurance quotes, offers to enter into insurance policy contracts, and/or issued insurance policy contracts in connection with transactions to purchase goods or services. By this technology, users may be able to efficiently and securely obtain accurate insurance quotes, offers and issued policies in timely manners.

In one aspect, a computer-implemented method for insurance policy application processing may be provided by one or more local or remote processors, transceivers, servers, memory units, and/or sensors operated by or on behalf of an insurance provider. The method may include (i) receiving via a mobile device of a quote requester or other user an electronic quote request including quote request information for an insurance quote for a product being offered by a product offeror. The quote request may be initiated via the mobile device in response to a wireless communication link between the mobile device and a proximity information source associated with the product offeror. The quote request information may be received by the mobile device from the proximity information source via the wireless communication link. The method may also include (ii) generating an insurance quote based upon the quote request information, and/or (iii) transmitting the insurance quote to the mobile device (e.g., for presentation to the user).

The proximity information source may be a QR code and include information about the location (e.g., website or other address information) of the one or more processors. For example, the QR code may be associated with a vehicle for sale, and include information such as the make, model, year, mileage on the vehicle, advanced vehicle safety features, autonomous or semi-autonomous vehicle systems or technologies, and/or other vehicle features or characteristics. As another example, the QR code may be associated with a home for sale, and include information such as the location, size, construction type of the home, square footage, number of floors, lot size, smart or intelligent home systems or technologies, and/or other home features or characteristics.

In some situations, the received quote request may have originated from the purchaser or user in connection with a transaction where information about the purchaser/user is collected by the product offeror (e.g., by a sales representative of the product offeror) and stored by a computer system operated by, or on behalf of, the product offeror. In such situations, the electronic quote request (e.g., as received from the scanned QR code) may include information (e.g., address information) about the location of that information in the product offeror's computer system. The purchaser/user information may then be accessed and retrieved from the product offeror's computer system by the one or more processors, and used in connection with the generation of the quote request.

For example, the identity and residence address of the purchaser/user, and background and financial history information, collected by sales representatives at a vehicle dealership in connection with a vehicle sale or at a real estate agency in connection with a home sale, may be automatically retrieved by the one or more processors and used to generate the insurance quote. The information about the purchaser or user may be sufficient to enable the one or more processors to automatically generate and provide an offer for a binding contract for an insurance policy under the terms of the quote.

In response to the receipt of information (e.g., from the mobile device) indicating the purchaser's or user's acceptance of such an offer, the one or more processors may provide an acknowledgment of the acceptance (e.g., an insurance contract binder) that the purchaser or user may use to complete the transaction. The method may include additional, less, or alternate functionality, including that discussed elsewhere herein.

In another aspect, a computer-implemented method for operating a mobile device is provided. The method may include, via one or more local or remote processors, transceivers, memory units, servers, and/or sensors, (i) wirelessly receiving insurance quote request information via a communication link with a proximity information source associated with a product offeror in response to operation of the mobile device by a quote requester or other user. The quote request information may include an insurance provider address, such as an address to an information system associated with an insurance provider. The method may also include, via one or more local or remote processors, transceivers, memory units, servers, and/or sensors, (ii) generating and transmitting to the insurance provider address an insurance quote request including the quote request information; (iii) receiving an insurance quote in response to the quote request; and/or (iv) displaying the insurance quote by a user interface of the mobile device. The insurance quote may have been generated by the information system of the insurance provider based upon the quote request information. The method may include additional, less, or alternate functionality, including that discussed elsewhere herein.

For example, the quote request information may be obtained from a QR code scanned by the mobile device. The quote request may be automatically initiated by the mobile device when the user scans the QR code. Alternatively, the mobile device may prompt the user to initiate the quote request after the QR code is scanned.

Advantages of the technology, including those described above, will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 is a depiction of an environment including an exemplary computer network of various components, including the mobile device and insurance provider computer system discussed herein, that may be operated in accordance with certain embodiments of the computer-implemented methods disclosed herein;

FIG. 2 is a depiction of components of the exemplary mobile device shown in FIG. 1, that may be operated by a user to provide the insurance application processing functionality detailed herein, and to facilitate the related computer-implemented methods, in accordance with certain embodiments;

FIG. 3 is a depiction of an exemplary computer system that may be used in connection with the exemplary computer network components to provide the insurance policy application processing functionality detailed herein, and to facilitate the related computer-implemented methods, in accordance with certain embodiments;

FIG. 4 illustrates an exemplary computer-implemented method that may be performed through the use of components of networked system, including the mobile device, to provide a user with insurance quotes, in accordance with certain embodiments;

FIG. 5 illustrates an exemplary computer-implemented method that may be performed through the use of components of the networked system, including the mobile device, to provide a user with insurance quotes, offers to enter into insurance policy contracts based upon the quotes, and binding insurance policy contracts, in accordance with certain embodiments;

FIG. 6 illustrates an exemplary computer-implemented method that may be performed through use of components of the networked system, including the computer system of the insurance provider, to provide a user with insurance quotes, in accordance with certain embodiments; and

FIG. 7 illustrates an exemplary computer-implemented method that may be performed through use of components of the networked system, including the computer system of the insurance provider, to provide a user with (i) insurance quotes; (ii) offers to enter into insurance policy contracts based upon the quotes; and/or (iii) binding insurance policy contracts, in accordance with the present embodiments.

FIG. 8 illustrates an exemplary computer-implemented method that may be performed through use of components of the networked system to provide sales contracts, insurance quotes, and/or loans for vehicle and homes using QR codes and/or NFC tags.

FIG. 9 illustrates an exemplary computer-implemented method that may be performed through use of components of the networked system to provide insurance quotes and/or loan terms for vehicle and homes using QR codes generated at vehicle dealerships or realtor locations, respectively.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

### Overview

Computer systems and computer-implemented methods disclosed herein provide technology solutions to problems associated with insurance products. In some aspects, computer systems and computer-implemented methods by which mobile devices may be operated by users to request and receive insurance quotes, offers and/or binding contracts. Additionally or alternatively, some aspects may include computer systems operated by or on behalf of insurance providers and computer-implemented methods by which insurance quotes, offers and/or binding contracts may be generated and provided to users requesting the insurance products.

By this technology, users may be able to efficiently obtain (i) accurate insurance quotes, (ii) insurance policy offers, and/or (iii) issued insurance policies in timely manners. For example, the insurance quotes, offers and contacts may be relatively quickly obtained during situations where they are needed, such as during or otherwise in connection with transactions involving products such as goods and/or services that may benefit from the insurance products.

The quotes, offers, and policies may be accurate, at least in part, because they are obtained based upon particular request information specific to the requesting user and/or the specific products being insured. The quotes, offers, and policies may be accurate, at least in part, because the request information used in connection with the preparation of the quotes, offers, and policies may be electronically and automatically obtained from sources of that information, and/or may be electronically and automatically submitted to the insurance provider. Efficiencies may be provided through the operation of the mobile device to automatically collect or otherwise receive the relevant request information used to prepare the insurance quotes, offers, and/or contracts.

The disclosed computer systems and methods make use of information received from proximity information sources associated with the products to be insured. Examples of such proximity information sources include QR (Quick Response) codes and NFC (Near Field Communication) tags. The proximity information sources may include quote request information that may be used to initiate the insurance quote. In some embodiments, the quote request information may also be used to initiate the issued insurance contracts based upon the quotes. The proximity information sources may include information identifying an insurance provider, and information about the product to be insured. The proximity information sources may also include information about the entity offering the product for which the insurance quote is being requested.

A user may scan the proximity information source using their mobile device to establish a communication link with the proximity information source, and receive the request information via the communication link. For example, the user may cause a camera of their mobile device to image the QR code.

In some aspects, the above-described advantages are provided by the user's mobile device operating in accordance with disclosed methods. In environments where a user is considering entering into a transaction for a product that may involve an associated insurance policy, the user may operate their mobile device to obtain an insurance quote for the product. For example, if the user is considering a transaction such as a purchase or lease of a vehicle at a vehicle dealership, the user may operate their mobile device to image a QR code associated with the vehicle. The QR code in this example may include the insurance quote request information for the vehicle under consideration, such as for example the make, model, year, mileage, and vehicle features, such as advanced vehicle features associated with autonomous or semi-autonomous technologies or systems.

Additionally or alternatively, if the user is considering a transaction such as a purchase or lease of a home, for example in connection with an open house at the home, the user may operate their mobile device to image a QR code associated with the home. The QR code in this example may include insurance quote request information for the home under consideration, such as for example the location, size, number of floors, square footage, lot size or acreage, type of roof or siding, number of windows, year built, smart home or intelligent home features or systems, and/or type of construction.

Operating the mobile device to image the QR code may initiate the generation and transmission of a request to the insurance provider for an insurance quote for the product. In some embodiments, the mobile device automatically initiates the quote request in response to the receipt of the request information from the QR code without further input from the user. In other embodiments, the user may be asked by the mobile device to confirm their desire to proceed with the request before the request is transmitted by the mobile device. In response to the request, an insurance quote for the product may be received (e.g., automatically) and displayed to the user by the mobile device. The user may then consider the insurance quote in connection with a transaction they are considering for the product.

In these or other environments, the user may be interacting with a sales representative of the product offeror in connection with the transaction being considered, and the sales representative may have obtained information about the user in connection with that interaction. In environments such as these, the information about the user obtained in connection with the transaction may be stored in a computer system associated with the product offeror. For example, in connection with transactions for vehicles or homes, user information that may be collected by a vehicle dealership or a real estate office may include identity, residence, and/or financial history or background of the user. In these environments, the QR code or other proximity information source associated with the sales representative or product offeror may include information identifying the location of the product offeror's computer system where the collected user information is stored.

In certain embodiments, the location of the product offeror's computer system that includes the user information may be received by the user's mobile device via the communication link when the QR code or other proximity information source is scanned in these environments. The product offeror information of this type may also be included in the information transmitted to the insurance provider's computer system as part of the insurance quote request. In some embodiments, the insurance quote received by the mobile device in response to the request may be based at least in part on the user information. For example, the insurance quote may be based upon a credit score or other information associated with the user obtained by the insurance provider's computer system based upon the user information. Because they may be based at least in part on the user information, the accuracy of insurance quotes provided in accordance with these embodiments may be enhanced.

In these and other embodiments, the insurance quote provided to the mobile device may include an offer to enter into a binding insurance contact under the terms of the quote. By operating the mobile device, the user may accept such an offer, and cause the acceptance to be transmitted to the insurance provider's computer system. The mobile device may also receive and display an acknowledgement of the issued insurance policy contract from the insurance provider. The user may then use the acknowledgement to enhance the efficiency of the transaction. For example, the user may show the issued insurance policy to the product offeror's sales representative to complete a transaction involving a vehicle or home.

In some aspects, the above-described features are provided by, or on behalf of, the insurance provider's computer system operating in accordance with the disclosed computer-implemented methods. In environments where the insurance quote request includes the specific information about the product under consideration by the user, the computer system of the insurance provider may generate the insurance quote based upon product information, and transmit the quote to the user's mobile device. Alternatively or additionally, if the quote request information includes information about a source of the information about the product, the computer system may (i) accesses and retrieve the product-specific information from the information source, and (ii) generate the insurance quote based upon the retrieved product information.

In environments where the quote request includes product offeror information, such as the location of the user information collected in the course of a transaction with a sales representative of the product offeror, the computer system of the insurance provider may access and retrieve the user information based upon the product offeror information, and generate the insurance quote based upon the user information. For example, the computer system may access a third party credit rating agency computer system to obtain a credit report on the user based upon the user information, and generate the insurance quote based upon the credit report. Alternatively or additionally, the computer system of the insurance provider may generate an offer to enter into a binding insurance policy contract with the user based upon the user information, and transmit the offer to the mobile device of the user. In certain embodiments, the computer system of the insurance provider may generate and wirelessly transmit over one or more radio frequency links to the mobile device of the user an acknowledgement of the issued insurance policy if the user accepts the offer. The user may thereby receive timely evidence of a binding insurance contract covering the product to facilitate completion of the transaction for the product.

At least one of the technical problems addressed by this system may include (i) the inability of a conventional computing devices to transmit detailed product information determined from codes or tags (such as QR codes, NFC tags, or RFID tags) on products for which new insurance coverage is desired; (ii) the inability of conventional remote servers to efficiently and timely generate accurate insurance quotes based upon detailed product information determined from codes or tags received from a customer's mobile device; (iii) the inability of conventional systems to quickly present accurate insurance quotes to potential customers for new products based upon codes or tags attached to the new products; and/or (iv) the inability of conventional techniques to quickly provide customers accurate and binding insurance coverage based upon the detailed product information embedded within codes or tags attached to products for which insurance coverage is desired.

A technical effect of the systems and processes described herein may be achieved by performing at least one of the following steps: (i) gathering, collecting, or otherwise determining from codes or tags (such as QR codes, NFC tags, or RFID tags) attached to the products, and transmitting, via a mobile device, detailed product information on products for which new insurance coverage is desired; (ii) generating, via one or more remote servers, accurate insurance quotes based upon the detailed product information embedded within, and/or determined from, the codes or tags received from a customer's mobile device; (iii) quickly generating and presenting, via the customer's mobile device, one or more accurate insurance quotes to potential customers for new products based upon codes or tags attached to the new products; and/or (iv) quickly providing customers accurate and binding insurance coverage based upon the detailed product information embedded within codes or tags attached to products for which insurance coverage is desired.

The technical effect achieved by this system may be at least one of: (i) the ability of a mobile device to gather, collect, or determine, and then transmit detailed product information on products for which new insurance coverage is desired from codes or tags attached to the products; (ii) the ability of one or more remote servers to generate accurate insurance quotes based upon the detailed product information embedded within, and/or determined from, the codes or tags received from a customer's mobile device; (iii) the ability of a mobile device to quickly generate and present one or more accurate insurance quotes to potential customers for new products based upon the codes or tags attached to the new products; and/or (iv) the ability to quickly provide customers accurate and binding insurance coverage based upon the detailed product information embedded within codes or tags attached to products for which insurance coverage is desired.

### Exemplary Networked System

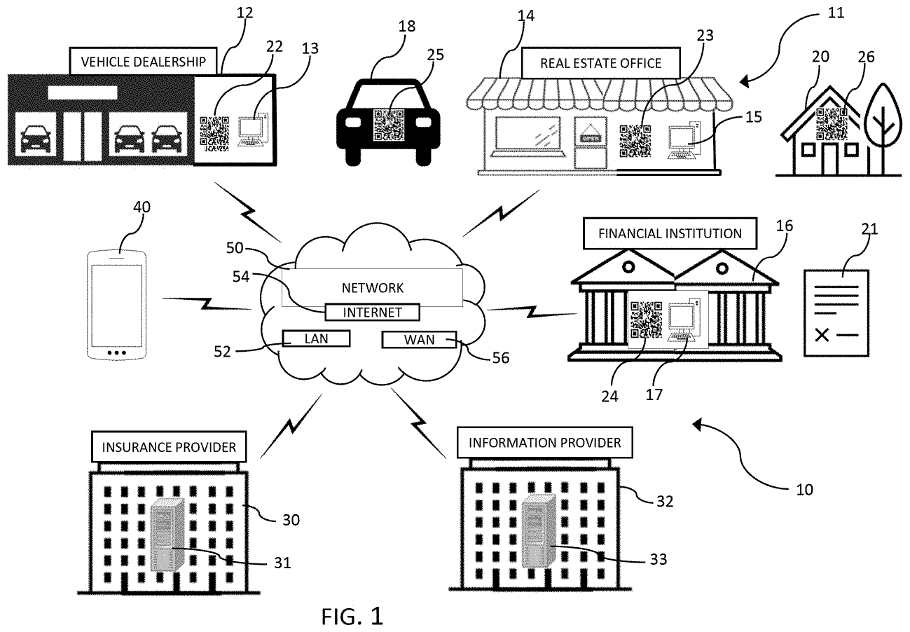

FIG. 1 is a diagrammatic illustration of an exemplary computing environment 10 including networked components that may be used and operated in accordance with insurance policy application processing methods described herein. The computing environment 10 may include a plurality of locations, including business entities 11, at which one or more steps in accordance with the computer-implemented methods may take place. The computing environment 10 may also include a plurality of goods, services, or other products in connection with which one or more steps in accordance with the methods may be used.

The exemplary business entities 11 shown in FIG. 1 may include a vehicle dealership 12, real estate office 14, and/or financial institution 16. Sales, leasing, rental, or other transactions in connection with vehicles 18, such as automobiles, may take place at the vehicle dealership 12. Transactions involving other types of vehicles, such as for example boats, motorcycles, trucks and construction equipment, and including autonomous and semi-autonomous vehicles, may also take place at the vehicle dealership 12.

Similarly, sales, leasing, rental, or other transactions in connection with real property, such as a home 20, may take place at the real estate office 14. Transactions involving other types of real property, such as for example farmsteads, commercial buildings and undeveloped land, may also take place at the real estate office 14. Sales of financial products, such as mortgages and other loans 21, may take place at financial institution 16, which may for example include a bank or credit union. Although illustrated as financial institution 16 in FIG. 1 for purposes of example, financial products of the type commonly provided by financial institutions may be provided by other entities in embodiments.

Additionally, although described herein in connection with the vehicle dealership 12, real estate office 14, financial institution 16, vehicle 18, home 20 and loans 21, the computer-implemented methods described herein are suitable for use with a wide range of other business entities 11 or at other transaction locations, and/or in connection with a wide range of other goods, services, or other products that may be insured. For example, vehicles such as vehicle 18 and real property such as home 20 may be subject to sales and other transactions at locations other than an auto dealership 12 and real estate office 14, respectively, such as for example in connection with direct sales between individual sellers and individual buyers (e.g., at the residence of the seller).

As shown in FIG. 1, the business entities 11 may include computer systems such as those shown diagrammatically at 13, 15 and 17 in connection with the vehicle dealership 12, real estate office 14 and financial institution 16, respectively. The computer systems 13, 15, 17 are illustrated as functional components in FIG. 1, and may include one or more known or otherwise conventional computer components, such as desktop computer systems, laptop computers or mobile devices such as tablets or smart phones. Computer systems 13, 15, 17 may, for example, include one or more keyboards, monitors, graphical user interfaces (GUI) or other interface components coupled to sources of computing resources such as servers operated by or on behalf of the associated business entities 11, or computing resources provided by third parties (e.g., cloud computing resources). Each of one or more sales or other representatives of the business entities 11 may have a computer system 13, 15, 17 (e.g., at or associated with their workspace). The computer systems 13, 15, 17 at the business entities 11 may be networked with one another, or stand-alone (e.g., not coupled to other computer systems at the business entities).

The computer systems 13, 15, 17 may provide business and other systems and software-based tools (including for example tools provided through software as a service (SaaS)) used by the representatives of the business entities 11 to perform their functions relating to the business entities. For example, the computer systems 13, 15, 17 may include sales, marketing, or other information about the products, such as for example vehicles 18, homes 20 and loans 21, offered by the business entities 11.

The computer systems 13, 15, 17 may include sales or other systems by which the representatives of the business entities 11 record information about purchasers or customers of the business entities in connection with transactions involving the products. For example, the business entities 11 may collect and record purchaser or customer information, such as name, address, occupation, and other identifying information, as well as financial status (e.g., financial accounts, current insurance policies, outstanding loans and debts) in connection with transactions involving the users.

The collected purchaser, customer or other user information may be stored in the computer systems 13, 15, 17 in conventional or otherwise known file structures to enable the efficient and accurate transfer of the information to the computer system 31 of the insurance provider 30 (e.g., to provide enhanced compatibility of data transfer). For example, the computer systems 13, 15, 17 may have address location information dedicated to the receipt of information for transactions and computer-implemented methods described herein to enhance the security of the information and the transfers of the information. The computer systems 13, 15, 17 may also host websites associated with the businesses.

The business entities 11 and/or products offered by the entities in the computing environment 10 may include one or more associated contactless or close proximity information elements or sources such as QR (quick response) codes. In the embodiments shown in FIG. 1, for example, the vehicle dealership 12, real estate office 14 and financial institution 16 have associated QR codes 22, 23 and 24, respectively, and vehicle 18 and home 20 have associated QR codes 25 and 26, respectively.

The QR codes 22-26 are examples of contactless or close proximity information elements or sources that may be used in connection with the methods described herein. Other embodiments may use other conventional or otherwise known contactless or close proximity information elements or sources, such as for example Near Field Communication (NFC) elements or sources and related technologies. Other embodiments may additionally or alternatively use radio-frequency identification (RFID) techniques and RFID tags attached to objects, such as a vehicle or home.

As described in greater detail below, the QR codes such as 22-26 (or RFID tags) may include information used in connection with the computer-implemented methods described herein to facilitate insurance policy application processing. In connection with these methods, the information included in the QR codes may be communicated wirelessly to other network components of the environment 10.

For example, the QR codes 22-24 at, or otherwise associated with, the vehicle dealership 12, real estate office 14, and financial institution 16, respectively, may include information about the business entity, such as its name or other identifying information, as well as (1) information such as addresses or locations of its computer or other information systems at which information regarding transactions are stored (e.g., information about purchasers, customer or other users that is collected in connection with the transactions), (2) information such as the addresses of websites of the entities, (3) information about the associated goods, services, or other products (e.g., vehicle 18, home 20, and loans 21) that are the subjects of the transactions at business entities, and/or (4) information such as addresses or locations of other sources of information about the goods, services, and/or other products being offered by the business entities (e.g., third party websites).

The QR code 25 at, or otherwise associated with, the vehicle 18 may include information about the vehicle, such as for example its vehicle ID (VIN), make, model, age, mileage, price, advanced safety features, autonomous or semi-autonomous features or systems, and/or condition, and/or information such as addresses or locations of other sources of information about the vehicles. The types of autonomous or semi-autonomous vehicle-related functionality or technology information about the vehicle included in the QR code 25 may include or indicate that the vehicle has the following functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; (j) adaptive cruise control; (k) automatic or semi-automatic parking/parking assistance; (l) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; (s) automatic or semi-automatic driving without occupants; and/or other functionality.

Similarly, the QR code 26 at, or otherwise associated with, the home 20 may include information about the structure, such as for example its address, zip code (e.g., location), size, construction type, price and/or condition, smart home or intelligent home systems or features, and/or information such as addresses or locations of other sources of information about the home.

The QR codes 22-26 may be presented in any conventional or otherwise known manner, such on printed point-of-sale stands or other displays (e.g., in the vehicle dealership 22, real estate office 14, financial institution 16 or home 20), point of sale tags (e.g., attached to the vehicle 18) or by electronic (e.g., video) display (e.g., on monitors of the computer systems at the vehicle dealership, real estate office, and/or financial institution). The QR codes 22-26 may also be available at websites or other publicly-available information sources provided by, or on behalf of, the associated business entities.

The computing environment 10 may also include one or more insurance providers 30. Insurance providers 30 may provide conventional or otherwise known insurance and related products. Examples of such insurance products include vehicle insurance policies (e.g., that may cover vehicles 18 subject to transactions at vehicle dealership 12 or other locations), real property insurance policies (e.g., that may cover structures such as homes 20 subject to transactions at real estate office 14 or other locations), and/or life insurance policies (e.g., in connection with loans 21 provided by financial institution 16). Insurance providers 30 may be business entities focused on providing insurance services, such as for example known insurance companies, or other entities that provide insurance-type products in connection with other business transactions.

Insurance provider 30 may have one or more associated computer systems 31 that may be used in connection with its business and the insurance application processing computer-implemented methods described herein. Although shown diagrammatically as a server in FIG. 1, the computer system 31 may have one or more of the components and features of the computer systems 13, 15, 17 described above in connection with vehicle dealership 12, real estate office 14, and financial institution 16. For example, the computer system 31 may host a website that is accessed by customers of the insurance provider 30.

The computer system 31 may also provide computing resources in connection with application programs, such apps, of the insurance provider that are operated on mobile devices or other computer systems of the customers of the associated business entities 11. For example, the insurance provider 30 may provide its own app that has been downloaded onto the mobile devices such as mobile device 40 of its customers, prospective customers or other users as is known or otherwise conventional.

Such insurance provider apps, for example, enable users to input information into the mobile device relating to applications for insurance, and insurance claims, and to provide administrative operations such as invoice payments in connection with the insurance policies. The computer system 31 may provide the computing resources that enable the functionality of the apps of the insurance provider 30. Although shown diagrammatically at the insurance provider 30 in FIG. 1 for purposes of example, the functionality of the computer system 31 may be provided by computing resources at other locations, and/or by or on behalf of the insurance provider by third parties, as described above in connection with computer systems 13, 15, 17.

Some embodiments of environment 10 may include one or more information providers 32. The information providers 32 may provide information that may be used in connection with the computer-implemented methods described herein. For example, the information providers 32 may be third parties that provide information and/or services used by the insurance providers 30 in connection with the processing of insurance policy applications. Examples of such information providers include credit rating services that may provide information such as credit ratings on individuals or other entities applying for or requesting insurance products from the insurance provider 30, and payment processors that process electronic payments and provide related services to the insurance providers.

As shown, the information provider 32 may have one or more associated computer systems 33 that may be used in connection with its business and the services it provides. Although shown diagrammatically as a server in FIG. 1, the computer system 33 may have one or more of the components and features of the computer systems 13, 15, 17 described above in connection with vehicle dealership 12, real estate office 14, and financial institution 16.

The computing environment 10 may also include one or more mobile devices 40 that may be used by, or on behalf of, customers, prospective customers or other users, such as individuals or other entities, in connection with the methods described herein. Such users may also be referred to as purchasers or product purchasers in this disclosure. As described in greater detail below, a user may use the mobile device 40 to establish a wireless communication link to, and to wirelessly obtain information from, the QR codes such as 22-26 (or other proximity information source such as an NFC tag or a RFID tag) in connection with insurance policy application processing.

In some embodiments, for example, mobile devices 40 may be used to initiate requests for quotes for insurance. In these and other embodiments, the mobile devices 40 may be used to complete or otherwise secure the issuance of the insurance policy (e.g., to accept offers to enter into binding insurance contracts based upon the quotes). Non-limiting examples of mobile devices 40 include mobile phones, tablets, hand-held scanners and other conventional or otherwise known devices that a user may use to establish a wireless communication link to QR codes, such as 22-26 or other proximity information sources.

### Exemplary Mobile Device

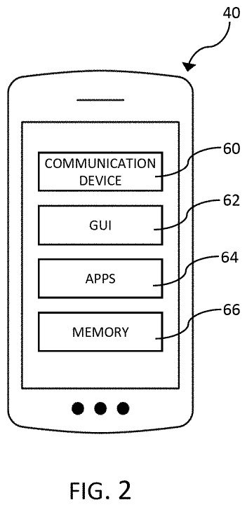

FIG. 2 is a diagrammatic illustration of an exemplary mobile device 40 and functional components thereof. As shown, the mobile device 40 may include a communication device 60, graphical user interface (GUI) 62, apps 64, and memory 66. In certain embodiments, and with the exception of the computer systems and associated software-implemented methods described herein and included in the mobile device 40, the mobile device may be a known or otherwise conventional and commercially-available device, such as a mobile phone or a tablet.

Communication device 60 may include a camera for imaging QR codes such as 22-26. Other embodiments may include other types of communication devices 60 to provide the contactless communication links described herein, such as for example a radio frequency (RF) device to enable communication links to NFC tags. GUI 62, which may include a touch screen or other keyboard and display, may be operated by the user in accordance with the methods described herein. Memory 66 may include information identifying the mobile device 40, for example by an address, to enable communications with the mobile device, as is known or otherwise conventional.

Application programs or apps 64 may be stored in the memory 66, and include known or otherwise conventional apps that provide the functionality associated with the communication device 60. For example, such apps 64 may operate the communication device 60 to image a QR code 22-26, and to process the information received from the QR code, in response to actuation of the GUI 62 by the user. As described in greater detail below, in some embodiments, the apps 64 may automatically execute instructions in response to information received from a QR code 22-26, such as accessing a website at an address identified in the received information, and/or automatically sending information received from the QR code to the accessed website.

Examples of other apps 64 that may be stored on the mobile device 40 may include one or more apps associated with the insurance provider 30 as described above, and/or an app that provides functionality associated with one or more steps of the computer-implemented methods described herein. Yet other examples of apps 64 that may be stored in the mobile device 40 may include encryption and/or decryption software for data communication security.

As shown in FIG. 1, the networked components of computing environment 10 may be connected for electronic data and other information communications, such as wireless communication over one or more radio frequency links, by a communications network 50. The network 50 is illustrated as a functional component in FIG. 1, and may include one or more wired and/or wireless (e.g., RF or optical) networks for connecting computer and other electronic systems of the environment 10 (e.g., computer systems 13, 15, 17, 31 and 33 and mobile device 40 in the illustrated embodiments).

In some embodiments, for example, the network 50 may include one or more local area networks (LAN) 52, internet 54 and one or more wide area networks (WAN) 56 coupling the networked components (e.g., computer systems 13, 15, 17, 31 and 33 and mobile device 40) of the environment 10. LAN 52 may, for example, include WiFi and near field communication networks such as Bluetooth. WAN 56 may include cellular networks.

### Exemplary Insurance Quote Process

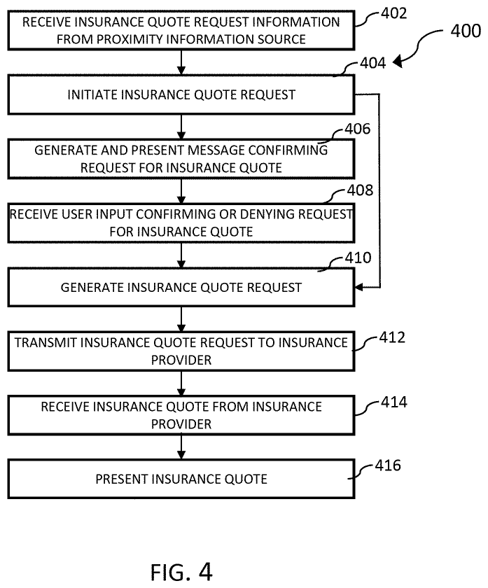

FIG. 4 illustrates an exemplary computer-implemented method 400 that may be performed by a mobile device 40 being operated by a quote requestor or other user to obtain and present insurance quotes in accordance with certain embodiments. The following description of method 400 is provided with reference to the environment 10 and associated networked components described above in connection with FIGS. 1-2 for purposes of example.

As shown by step 402, the mobile device 40 of, or associated with, the user requesting the insurance quote receives a quote request including certain quote request information. The user may initiate the quote request and receipt of the quote request information by operating the mobile device 40 to establish a communication link via the communication device 60 with the proximity information source associated with a product for which the insurance quote is being requested. For example, the user may operate the mobile device 40 to actuate the device's camera, and to optically image the QR code 24 located at the financial institution 16 in connection with a life insurance policy on the user in connection with the loan 21. In other exemplary embodiments, the user may image the QR code 25 of a vehicle 18 at an auto dealership 22 in connection with an insurance policy for the vehicle, or the QR code 26 of a home 20 the user is touring during an open house in connection with an insurance policy for the home.

The quote request information may be encoded in the QR code or other proximity information source, and may be received by the mobile device 40 via the wireless communication link. The quote request information may include insurance provider information, such as for example address information, to the computer system 31 of the insurance provider 30 that will provide the insurance quote. The address information may, for example, include the URL (Uniform Resource Link) to the website of the insurance provider 30. The address information may include information to a specific functional location at the website used by the computer system 31 to process insurance quote requests.

The quote request information may also include product information about the product that enables the insurance provider 30 to provide the quote for the product. In certain embodiments, for example, the product information of the quote request information is direct product information about the product itself. The direct product information is information sufficient to enable the computer 31 of the insurance provider 30, either by itself or in combination with information provided by an information provider 32, to provide the insurance quote. As described above, for example, product information included in the QR code 25 on the vehicle 18 may include information about the vehicle, such as make, model, year, mileage, advanced safety features, autonomous or semi-autonomous technology or systems, etc. Product information included in the QR code 26 at the home 20 may include information about the home, such as its size, construction type, location, age, square footage, number of floors, number of bedrooms and bathrooms, type of roofing, smart home or intelligent home functionality and sensors, type of materials, size and number of windows, type of flooring and cabinets, size of lot, etc.

Alternatively or additionally, the quote request information received at step 402 may include indirect product information. The indirect product information may be information representative of one or more sources of information from which the information about the product itself may be obtained. As described above, for example, the indirect product information may include information identifying the products for which the insurance quotes are requested, and addresses or links to information sources at which information about the products themselves (e.g., information similar to the direct product information) is located.

For example, the indirect product information included in the QR code 25 of a vehicle 18 may include an identifier of the vehicle and address information to locations at the computer system 13 of the vehicle dealership 12 offering the vehicle (e.g., the URL to the website of the vehicle dealership), as well as include information about the vehicle and vehicle features or characteristics. Similarly, the indirect product information included in the QR code 26 of a home 20 may include an identifier of the home and address information to locations at the computer system 15 of the real estate office 14 offering the home, and/or include the information about the home and home features or characteristics.

In response to the receipt of the quote request information, mobile device 40 processes the quote request information (e.g., by an app 64) and initiates actions to generate a quote request as shown at step 404. In certain embodiments, for example, the mobile device 40 may generate, and display to the user on the GUI 62, a message requesting confirmation of the quote request as shown at step 406. Such a confirmation request message may, for example, be provided as a text-based question on the GUI 62 along with a radio button, or other graphical control element, that may be actuated by the user to answer the question.

The user may then provide input, for example by actuating the graphical control element on the GUI 62 representative of a “Yes” or “No” response to the confirmation request message as shown at step 408. If a “No” response input is received at step 408, computer-implemented method 400 may end the quote request process.

If a “Yes” response input is received at step 408, computer-implemented method 400 may generate an insurance quote request as shown at step 410. The insurance quote request may include the product information received as part of the quote request information (e.g., the direct and/or indirect product information).

As shown in FIG. 4, other embodiments of computer-implemented method 400 may not include steps 406-408. In these alternative embodiments, the mobile device 40 causes the quote request to be generated at step 410 following the initiation of the quote request process at step 404. For example, the mobile device 40 may automatically generate the insurance quote request at step 410 in response to the initiation of the quote request at step 404. By these alternative embodiments, the method 400 effectively acts on the receipt of the quote request at step 402 as confirmation of a user's request to generate the quote, without the intermediate steps 406 and 408.

At step 412, the mobile device 40 may transmit the insurance quote request to the insurance policy provider 30 over the network 50. The insurance quote request is transmitted to the insurance policy provider 30 at the address (e.g., to the website) associated with the address information received as part of the quote request information. The insurance quote request includes information identifying the source of the quote request, such as for example the IP (internet protocol) address of the mobile device 40, to enable the mobile device to receive responses to the quote request. As described in greater detail below, in response to the insurance quote request, the computer system 31 of the insurance provider 30 may generate an insurance quote based at least in part upon the product information included in the quote request, and transmit the insurance quote to the insurance mobile device 40. The quote request may be encoded by conventional or otherwise known encryption methods for enhanced security.

At step 414, the mobile device 40 receives the requested insurance quote from the insurance provider 30 over the network 50. The mobile device 40 decrypts the insurance quote if it was encrypted. Information in the received insurance quote may then be presented to the user as shown at step 416. In certain embodiments, for example, the insurance quote may be displayed as an image, and/or in text-based form, on the GUI 62 of the mobile device 40. The user may then review the information in the insurance quote on the GUI 62, and consider that information in connection with the transaction of the product with which the quote was associated. For example, the user's decision about whether to contact a sales representative at the vehicle dealership 12 to discuss options for transactions involving the vehicle 18 on display in a lot may depend upon the price and/or other terms contained in the insurance quote. Similarly, the user's decision about whether to contact an agent at the real estate office 14 to discuss options for transactions involving the home 20 that they are touring during an open house may depend upon the price and/or other terms contained in the insurance quote. The quote request may be encoded by conventional or otherwise known encryption methods for enhanced security.

The computer-implemented method may include additional, fewer or alternative steps, including those discussed elsewhere herein. The steps of the method may also be performed in different orders.

### Exemplary Insurance Quote Request & Contract Issuance Process

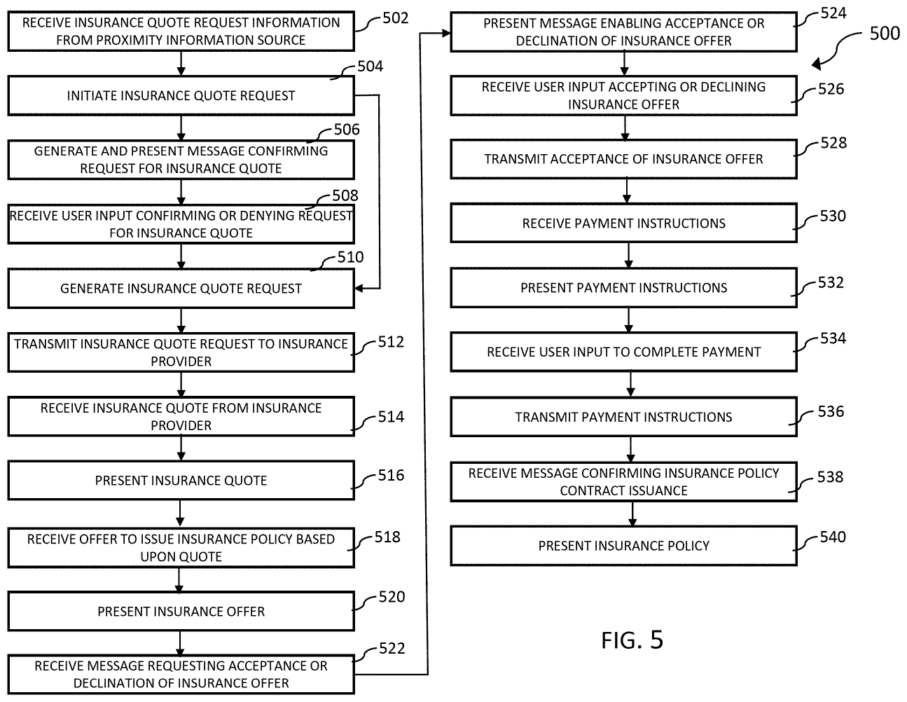

FIG. 5 illustrates an exemplary computer-implemented method 500 that may be performed by a mobile device 40 being operated by a quote requester or other user to obtain and present insurance quotes, and to obtain the issuance of insurance contracts, in accordance with certain embodiments. The following description of computer-implemented method 500 is provided with reference to the computing environment 10 and associated networked components described above in connection with FIGS. 1-2 for purposes of example.

The computer-implemented method 500 may be used in environments where the user is considering a transaction such as a sale, rental, or lease of a product where an insurance policy associated with the product is desired or perhaps necessary for completion of the transaction. For example, when a user is purchasing or leasing a vehicle 18 at a vehicle dealership 12, or purchasing or leasing a home 20 at a real estate office 14, the user may need to show evidence of a completed or binding insurance contract on the vehicle or home issued by an insurance provider 30 before the user can take possession of the vehicle or home. When a user is purchasing a loan 21 from a financial institution 16, the user may need to show evidence of a completed or binding life insurance policy on the user or some other party before the financial institution will issue the proceeds of the loan.

In connection with transactions of these types, the sales agents or other representatives of the product offeror, such as vehicle dealership 12, real estate office 14, or financial institution 16, may typically obtain certain purchaser information about the user, and enter that purchaser information into their computer systems, such as computer systems 13, 16 or 17, respectively. The purchaser information collected during these transactions may, for example include one or more of identity, residence, and contact information about the user, or information about the user's financial situation or history such as social security number, bank accounts, and credit accounts (e.g., if the user is financing a portion, or all of, the monetary payment for the transaction).

Purchaser information of these types may be collected at the point-of-sale during the transaction, or prior to the completion of the transaction. For example, the purchaser information may be obtained orally or electronically by a representative of the product offeror (e.g., over the telephone or while the user is at the vehicle dealership 12, real estate office 14, or financial institution 16). Alternatively or additionally, the purchaser information may be provided to the product offeror by the user before, or after, a personal meeting between the user and the representative of the product offeror (e.g., by the purchaser entering the information into fields of forms on the product offeror's website). Alternatively or additionally, the purchaser information may be provided to the insurance provider through the insurance providers' app on the mobile device.

The purchaser information collected in connection with the transactions may be used in certain embodiments of the computer-implemented method 500 described in connection with FIG. 5. In some embodiments, the purchaser information may be stored at locations in computer systems associated with the product offerors, such as computer systems 13, 15 or 17, that are specific for, or dedicated to, the particular transaction involving the user and the product, such as vehicle 18, home 20, or loan 21, respectively.

As shown by step 502, the mobile device 40 of, or associated with, the user requesting the insurance quote receives a quote request including certain quote request information. The user may initiate the receipt of the quote request information by operating the mobile device 40 to establish a communication link via the communication device 60 with the proximity information source associated with a product for which the insurance quote is being requested. In certain embodiments, step 502 may be performed by the user at the point-of-sale, while meeting with representatives of the product offeror in connection with the product transaction. For example, the user way operate the mobile device 40 to actuate the device's camera, and to optically image a QR code 22, 23, or 24 located at desks of the sales representatives of the vehicle dealership 12, real estate office 14, or financial institution 16, respectively, while meeting with the sales representatives.

In other embodiments, the QR code such as 22, 23, or 24 may be imaged from a visual representation of the QR code presented on a monitor of the user at a location remote from the product offeror. For example, the product offeror may provide the user with access to the QR code through the website of the product offeror, and the user may operate their mobile device 40 to image that QR code.

The quote request information may be encoded in the QR code such as 22, 23, or 24, and may be received by the mobile device 40 via the wireless communication link. The quote request information may provide information, such as for example insurance provider address information, to the computer system 31 of the insurance provider 30 that will provide the insurance quote. The insurance provider address information may, for example, include the URL (Uniform Resource Link) to the website of the insurance provider 30. Alternatively or additionally, the insurance provider address information may include information to a specific functional location at the website or location used by the computer system 31 to process insurance quote requests.

The quote request information may also include product information about the product that enables the insurance provider 30 to provide the insurance quote for the product. In certain embodiments, for example, the product information is direct product information about the product itself. The direct product information is information that is sufficient to enable the computer 31 of the insurance provider 30, either by itself or in combination with information provided by an information provider 32, to provide the insurance quote. As described above, for example, product information included in the QR code 22 of the vehicle dealership 12 may include information about the vehicle 18, such as make, model, year, mileage, and/or other vehicle features or characteristics, associated with the transaction (e.g., that the user is considering purchasing). Product information included in the QR code 23 of the real estate office 14 may include information about the home 20, such as its size, construction type and location, and/or other home characteristics or features, associated with the transaction (e.g., that the user is considering purchasing).

Alternatively or additionally, the product information received at step 502 may include indirect product information. The indirect product information is information representative of sources of information from which the information about the product itself may be obtained. As described above, for example, the indirect product information may include information identifying the products for which the insurance quotes are requested, and addresses or links to information sources at which information about the products themselves (e.g., information similar to the direct product information) is located. For example, the indirect product information included in the QR code 22 associated with a vehicle 18 may include an identifier of the vehicle and address information to locations at the computer system 13 of the vehicle dealership 12 offering the vehicle (e.g., the URL to the website of the vehicle dealership) including the information about the specific vehicle. Similarly, the indirect product information included in the QR code 23 associated with a home 20 may include an identifier of the home and address information to locations at the computer system 15 of the real estate office 14 offering the home and including the information about the home.

The quote request information received at step 502 may also include product offeror address information identifying the location at the product offeror's computer system at which the purchaser information that that was collected by the product offeror in connection with the transaction as described above is stored. For example, the information received from the QR codes 22, 23, or 24 may include address information to the locations in the computer systems 13, 15, or 17 of the vehicle dealership 12, real estate office 14, or financial institution 16, respectively, at which the collected purchaser information is stored.

In response to the receipt of the quote request information, mobile device 40 processes quote request information (e.g., by an app 64) and initiates actions to generate a quote request as shown at step 504. In certain embodiments, for example, the mobile device 40 may generate, and display to the user on the GUI 62, a message requesting confirmation of the quote request as shown at step 506. Such a confirmation request message may, for example, be provided as a text-based question on the GUI 62 along with a radio button, or other graphical control element, that may be actuated by the user to answer the question. The user may then provide input, for example by actuating the graphical control element on the GUI 62 representative of a “Yes” or “No” response to the confirmation request message as shown at step 508. If a “No” response input is received at step 508, the method 500 may end the quote request process.

If a “Yes” response input is received at step 508, the method 500 may generate an insurance quote request as shown at step 510. The insurance quote request generated at step 510 may include at least portions of the quote request information, such as the product information and the product offeror address information. As shown in FIG. 5, other embodiments of method 500 do not include steps 506-508.

In these alternative embodiments, the mobile device 40 causes the quote request to be generated at step 510 following the initiation of the quote request process at step 504. For example, the mobile device 40 may automatically generate the insurance quote request at step 510 in response to the initiation of the quote request at step 504. By these alternative embodiments, the method 500 effectively acts on the receipt of the quote request at step 502 as confirmation of a user's request to generate the quote request, without the intermediate steps 506 and 508. The quote request may be encoded by conventional or otherwise known encryption methods for enhanced security.

At step 512, the mobile device 40 may transmit the insurance quote request to the insurance policy provider 30 over the network 50. The insurance quote request may be transmitted to the insurance policy provider 30 at the address (e.g., to the website) associated with the insurance provider address information received as part of the quote request information at step 502. The insurance quote request may include information identifying the source of the quote request, such as for example the IP (internet protocol) address of the mobile device 40, to enable the mobile device to receive responses to the quote request. As described in greater detail below, in response to the insurance quote request, the computer system 31 of the insurance provider 30 may generate an insurance quote based at least in part upon the product information included in the quote request. In certain embodiments, the computer system 31 of the insurance provider 30 may generate the insurance quote based at least in part upon the purchaser information included in the quote request. The insurance quote generated by the insurance provider 30 may be transmitted by the insurance provider to the mobile device 40.

At step 514, the mobile device 40 may receive the requested insurance quote from the insurance provider 30 over the network 50. The insurance quote may be decrypted if was received in encrypted form. Information in the received insurance quote may then be presented to the user as shown at step 516. In some embodiments, for example, the insurance quote may be displayed as an image, and/or in text-based form, on the GUI 62 of the mobile device 40. The user may then review the information in the insurance quote (and/or the insurance policy) on the GUI 62, and consider that information in connection with the transaction with which the quote was requested.

At step 518, the mobile device 40 may receive an offer from the insurance provider 30 to enter into a binding contract with the user, and to issue an insurance policy based upon the quote received at step 514. For example, the insurance provider 30 may have received sufficient information from the user, including the purchaser information, to enable the insurance provider to make the offer at step 518.

At step 520, the mobile device 40 may present the offer, including associated information, to the user. In certain embodiments, for example, the insurance offer may be displayed as an image, and/or in text-based form, on the GUI 62 of the mobile device 40. The offer received from the insurance provider 30 is decrypted by the mobile device 40 before being presented.

At step 522, the mobile device 40 may receive a message from the insurance provider 30 requesting instructions from the user about whether they would like to accept the offer presented at step 520. The message received at step 522 may be presented by the mobile device 40 to the user at step 524. In certain embodiments, for example, the mobile device 40 may generate and display the message to the user as an image or in text-based form on GUI 62.

As shown at step 524, the message may include elements enabling the user to respond to the message. For example, the message presented at step 524 may include one or more radio buttons, or other graphical control elements, that may be actuated by the user to answer the question (e.g., to accept the offer). The user may then provide input, for example by actuating the graphical control element on the GUI 62 representative of a “Yes” or “No” response to the offer message as shown at step 526.

If a “No” response input received at step 526, the method 500 may end the insurance quote request and contract issuance process without issuing the policy. If a “Yes” response input is received at step 526, a message indicating the user's acceptance of the insurance offer may be transmitted by the mobile device 40 to the computer system 31 of the insurance provider 30 over the network 50 as shown by step 528. Although described as separate steps 520, 522, and 524 in connection with FIG. 5, in other embodiments steps 522 and/or 524 may be incorporated into step 520 (e.g., the message and graphical response elements may be included with the presentation of the offer at step 520).

Insurance provider 30 may request payment for all or portions of the offered insurance policy before issuing the policy. In the embodiments illustrated in FIG. 5, the mobile device 40 may receive payment instructions in connection with such a payment request as shown at step 530. The payment instructions received at step 530 may, for example, be received from the computer system 31 of the insurance provider 30, or from a computer system of a third party payment processor (not shown in FIG. 1 or 2) on behalf of the insurance provider.

At step 532, the mobile device 40 may present the payment instructions to the user, for example, by display on the GUI 62. The payment instructions presented at step 532 may include graphical control and input elements enabling the user to input the payment information, such as the user's credit card information, in known or otherwise conventional manners. At step 534, the user may input the payment information, for example through the GUI 62. The received payment information may then be transmitted by the mobile device 40 (e.g., to the insurance provider 30 or payment processor) as shown at step 536.

At step 538, the mobile device 40 may receive a message confirming or acknowledging the issuance of the insurance policy contract. As described below, the message received at step 538 may be transmitted from the computer system 31 of the insurance provider after the insurance provider confirms receipt of the user's payment for the insurance policy. If the acknowledgement message is received in encrypted form, it may be decrypted by the mobile device 40. The insurance policy acknowledgement message may be presented on the mobile device 40 at step 540, for example, as an image and/or text-based display on the GUI 62.

The user may then use the acknowledgement and other information of the issued insurance contract in connection with the transaction. For example, the user may show the acknowledgment of the insurance policy to the sales representatives of the product offeror to enable completion of the transaction.

The computer-implemented method may include additional, fewer or alternative steps, including those discussed elsewhere herein. The steps of the method may also be performed in different orders.

### Exemplary Insurance Quote Preparation Process

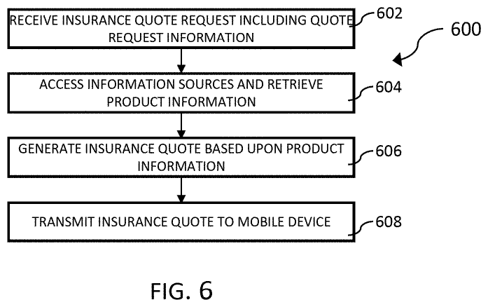

FIG. 6 illustrates an exemplary computer-implemented method 600 that may be performed by a computer system 31 operated by, or on behalf of, an insurance provider 30 to generate and provide insurance quotes in accordance with certain embodiments. The following description of computer-implemented method 600 is provided with reference to the environment 10 and associated networked components described above in connection with FIGS. 1-2 for purposes of example.

As shown by step 602, the computer system 31 of, or associated with, the insurance provider 30 may receive an insurance quote request including certain quote request information. As described above, the quote request may be received from the mobile device 40 via network 50. In some embodiments, the quote request received from the mobile device 40 is encoded, and may be decoded by the computer system 31.

The quote request information may include product information about a product, such as a vehicle 18 or a home 20, that the user of the mobile device 40 is considering purchasing and insuring. The product information received at step 602 may be information that is sufficient for the computer system 31 to generate the quote. As described above, in some embodiments, the product information may include direct product information about the product itself. Such direct product information may include information that the insurance provider 30 may use in connection with the generation of a quote to insure the product, such as for example the make, model, year, mileage, and/or other features or characteristics of a vehicle 18, or the size, construction type, location, and/or other features or characteristics of a home 20

Alternatively or additionally, the product information received at step 602 may include indirect product information that represents or defines sources of information from which the information about the product itself may be obtained. For example, the indirect product information may include information identifying the products for which the insurance quotes are requested, and addresses or links to information sources, such as third party or other websites, at which the information about the products is located. In connection with insurance quote requests including such indirect product information, the computer system 31 of the insurance provider 30 may access the sources of the product information, and retrieve the information, as shown at step 604.

At step 606, the computer system 31 may generate an insurance quote for the product based upon the product information received at steps 602 and/or 604. In certain embodiments, the computer system may generate the insurance quote automatically based upon the product information, including the types of product information discussed herein. Conventional or otherwise known insurance decisioning engines and algorithms may be used by the computer system 31 at step 606. The quote may contain information of the types conventionally provided in insurance quotes, such as for example the price, coverages, limits, deductibles, exclusions, and other terms.

At step 608 of the computer-implemented method 600, the computer system 31 may transmit the insurance quote to the mobile device 40 of the user requesting the quote (e.g., via the network 50). The quote request may be encoded by the computer system 31 before transmission to the mobile device 40. As described above, the insurance quote may then be presented to the user by their mobile device 40.

The computer-implemented method may include additional, fewer or alternative steps, including those discussed elsewhere herein. The steps of the method may also be performed in different orders.

### Exemplary Insurance Quote Preparation & Contract Issuance

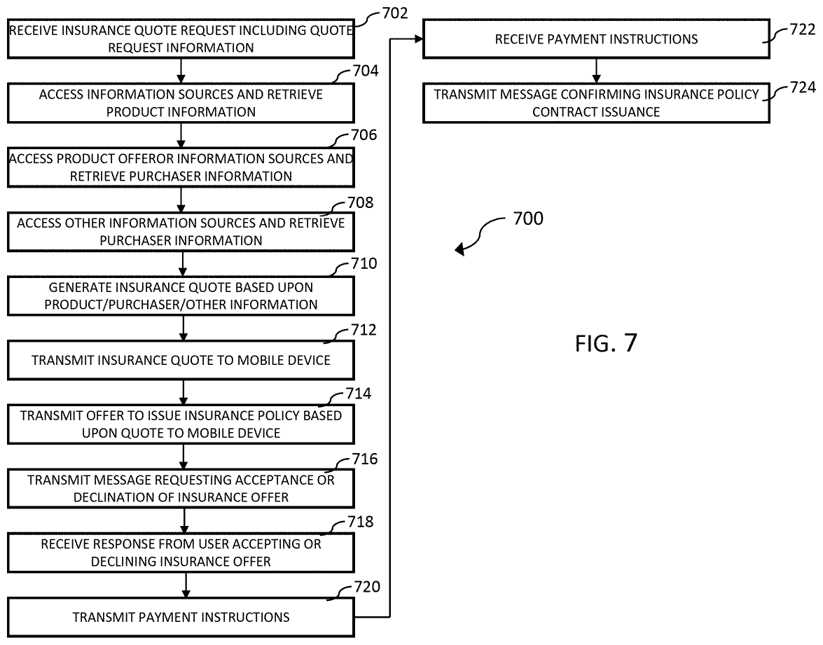

FIG. 7 illustrates an exemplary computer-implemented method 700 that may be performed by a computer system 31 operated by, or on behalf of, an insurance provider 30 to (i) prepare and provide insurance quotes; (ii) to prepare and provide insurance offers; and/or (iii) to issue insurance policy contracts in accordance with certain embodiments. The following description of computer-implemented method 700 is provided with reference to the computing environment 10 and associated networked components described above in connection with FIGS. 1-2 for purposes of example.

As shown by step 702, the computer system 31 of, or associated with, the insurance provider 30 may receive an insurance quote request including certain quote request information. As described above, the quote request may be received from the mobile device 40 via network 50. In certain embodiments, the quote request received from the mobile device 40 may be encoded, and may be decoded by the computer system 31.

The quote request information may include product information about a product, such as a vehicle 18 or a home 20, that the user of the mobile device 40 may be considering insuring. The product information received at step 702 may be information that is sufficient for the computer system 31 to generate the quote. As described above, in certain embodiments the product information may include direct product information about the product itself. Such direct product information may include information that the insurance provider 30 may use in connection with the generation of a quote to insure the product, such as for example the make, model, year, mileage, and/or other features or characteristics of a vehicle 18, or the size, construction type, location, and/or other features or characteristics of a home 20.

Alternatively or additionally, the product information received at step 702 may include indirect product information that represents or defines sources of information from which the information about the product itself may be obtained. For example, the indirect product information may include information identifying the products for which the insurance quotes are requested, and/or addresses or links to information sources, such as third party or other websites, at which the information about the products is located. In connection with insurance quote requests including such indirect product information, the computer system 31 of the insurance provider 30 may access the sources of the product information, and retrieve the information, as shown at step 704.

The insurance quote request information received at step 702 may include product offeror address information in embodiments. As described above, the product offeror address information may include information defining one or more locations at one or more computer systems associated with the product offeror, such as for example computer systems 13, 15, 17 of vehicle dealership 12, real estate office 14, or financial institution 16, respectively, including purchaser information about the user (and prospective purchaser) that was collected in connection with the transaction for the product.

The product offeror address information may, for example, define a particular location in the product offeror's computer system at which the purchaser information about the user is stored. The purchaser information that may be stored by the product offeror's computer system may include information that the insurance provider 30 may use to generate the insurance quote and/or an offer to enter into a contract, and issue an insurance policy based upon the quote. Examples of such purchaser information includes one or more of identity, residence address, and contact information about the user, or information about the user's financial background or history.

As shown at step 706, the computer system 31 of the insurance provider 30 may access the sources of purchaser information, and retrieve the user information. The customer or other use information may be provided in conventional or otherwise known data structures to enable that information to be efficiently and accurately transferred to the computer system 31 of the insurance provider 30 (e.g., to automatically associated data fields in the computer system of the insurance provider).

In embodiments, the product information and/or purchaser information obtained by steps 704 and 706 is sufficient to enable the computer system 31 of the insurance provider 30 to generate the insurance quote and/or an offer to issue the insurance policy. As shown by step 708, in other embodiments, the computer system 31 may access yet other information sources, such as those provided by a computer system 33 of a third party information provider 32, for additional purchaser or other information that may be used by the insurance provider 30 to generate the insurance quote and/or offer to issue the insurance policy. For example, the information provider 32 may be a credit rating agency. At step 708, the computer system 31 of insurance provider 30 may access the computer system 33 of the information provider 32 for a credit score for of the user, for example based upon the quote request information such as the purchaser information obtained by step 706.

At step 710, the computer system 31 may generate an insurance quote for the product based upon the product information, purchaser information and/or additional information received at one or more of steps 702, 704, 706, or 708. In certain embodiments, the computer system 31 may generate the insurance quote automatically, using conventional or otherwise known insurance decisioning engines and algorithms used by one of ordinary skill in the art. The insurance quote may contain information of the types conventionally provided in insurance quotes, such as for example the price, coverage, deductibles, limits, exclusions, endorsements, and other terms.

At step 712 of the computer-implemented method 700, the computer system 31 may transmit the insurance quote to the mobile device 40 of the user requesting the quote (e.g., via the network 50). In certain embodiments, the insurance quote may be encrypted by the computer system 31 before it is transmitted. As described above, the insurance quote may then be presented to the user by their mobile device 40.

At step 714, the computer system 31 of the insurance provider 30 may transmit to the mobile device 40 an offer to enter into a binding contract with the user, and to issue an insurance policy based upon the quote provided at step 712. The offer may be encoded by the computer system 31 before it is transmitted. The computer system 31 may transmit the offer to enter into the insurance policy contract, for example, if sufficient information, including the purchaser information an any additional information received at steps 706 and 708, was received to enable the decision (e.g., if predetermined criteria for providing an offer are met). The transmitted offer may include contract terms and other information that is sufficient to form a binding contract between the user and the insurance provider 30 upon acceptance by the user.

At step 716, the computer system 31 may transmit to the mobile device 40 a message asking the user if they would like to accept the offer transmitted at step 714. At step 718, the computer system 31 may receive a response to the messages transmitted at steps 714 and 716.

If a “No” response representing the user's declination of the offer is received at step 718, the computer system 31 may end the insurance quote and issue process of method 700. Although described as separate steps 714 and 716 in connection with FIG. 7, step 716 may be incorporated into step 714 in embodiments (e.g., the message requesting acceptance or declination of the offer may be included with the transmitted offer).

If a “Yes” response representing the user's acceptance of the offer is received at step 718, the insurance provider 30 may request payment for all or portions of the offered insurance policy before issuing the policy. In the embodiments shown in FIG. 7, the computer system 31 causes payment instructions to be transmitted to the mobile device 40 of the user as shown at step 720. The payment instructions may be transmitted directly by the computer system 31. In other embodiments, the insurance provider 30 uses a third party payment processor for payment processing, and may have such a payment processor send the payment instructions on its behalf at step 720.

At step 722, the computer system 31 of the insurance provider 30 may receive payment information from the user (e.g., directly from the user, or through a third party payment processor). Following the receipt of the payment, and completion of any other actions that may be necessary to enter into the insurance policy contract, the computer system 31 may transmit to the mobile device 40 of the user an acknowledgment of the issuance of the insurance policy contract as shown at step 724. The acknowledgment may be encoded, and may include a document or other information that the user may display on their mobile device 40, and present to the representatives of the product offeror, such as the vehicle dealership 12, real estate office 14, or financial institution 16, as may be needed in connection with the transaction (e.g., to complete the transaction).

The computer-implemented method may include additional, fewer or alternative steps, including those discussed elsewhere herein. The steps of the method may also be performed in different orders.

### Exemplary Computer Systems

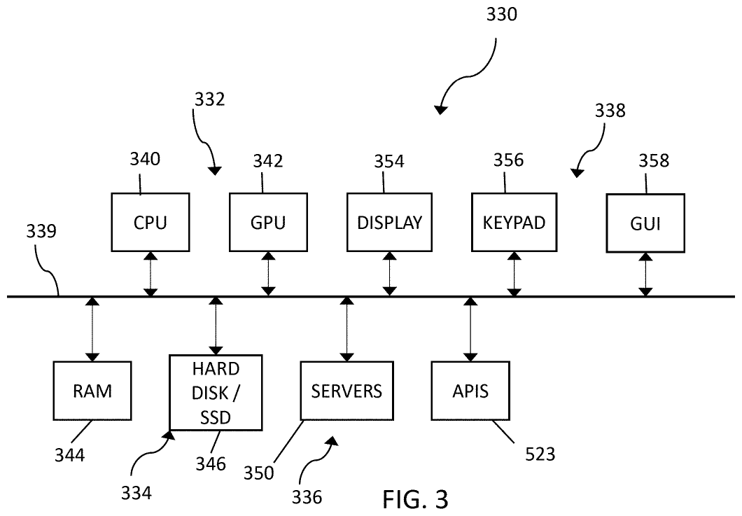

FIG. 3 is a diagrammatic illustration of an exemplary computer system 330 that may be used to implement one or more of the computer systems 13, 15, 17, 31, and 33 and/or mobile device 40 in accordance with some embodiments to provide the insurance policy application processing methods described herein. The illustrated embodiments of computer system 330 may include processing components 332, storage components 334, network interface components 336, and user interface components 338 coupled by a system network or bus 339.

Processing components 332 may, for example, include central processing unit (CPU) 340 and graphics processing unit (GPU) 342, and provide the processing functionality of the computer systems or mobile devices 40. The storage components 334 may include RAM memory 344 and hard disk/SSD memory 346, and provide the storage functionality of the computer systems or mobile devices 40.

For example, operating system software used by the processing components 332 and one or more applications or apps used to implement methods described herein may be stored by the storage component 334. By way of example, software executed by the apps 64 of the mobile devices 40, and/or software executed to provide the functionalities (e.g., method steps) of the insurance provider computer system 31 as described herein, may be stored by the storage components 334.

In some embodiments, the network interface components 336 may include one or more web servers 350 and one or more application programming interfaces (APIs) 352 to implement interfaces between the computer systems 13, 15, 17, 31, 33 and/or mobile devices 40. Examples of user interface components 338 may include display 354, keypad 356, and graphical user interface (GUI) 358. Some embodiments of computer system 330 may include other conventional or otherwise known components to provide the insurance policy application processing methods described herein.

### Exemplary Computer-Implemented Methods

In one aspect, a computer-implemented method for insurance policy application processing may be provided. The method may be implemented by one or more local or remote processors, transceivers, cameras, sensors, servers, and memory units. The method may include (1) receiving via a mobile device of a quote requester an electronic quote request including quote request information for an insurance quote for a product being offered by a product offeror, (2) generating an insurance quote based upon the quote request information, and (3) transmitting the insurance quote to the mobile device. The quote request may be initiated via the mobile device in response to a wireless communication link between the mobile device and a proximity information source associated with the product offeror. The quote request information may be received by the mobile device from the proximity information source via the wireless communication link and/or over one or more radio frequency links.

The quote request information may include product information. Generating the insurance quote may include generating the insurance quote based upon the product information.

The quote request information may include a product offeror address to an information source associated with the product offeror including quote requester information. The method may include (1) transmitting a quote information request to the product offeror address, and (2) receiving the quote requester information in response to the quote information request. Generating the insurance quote may include generating the insurance quote based upon the product information and the quote requester information.

The computer-implemented method may include generating an offer for an insurance policy contract based upon the insurance quote, and transmitting the offer for the insurance policy contract to the mobile device. The method may also include receiving via the mobile device an acceptance of the offer for the insurance policy contract, and transmitting an acknowledgement of an issuance of the insurance policy contract to the mobile device.

Receiving the quote request may include receiving a product offeror address to an information source associated with the product offeror and including product information. The method may include transmitting a quote information request to the product offeror address, and receiving the product information in response to the quote information request. Generating the insurance quote may include generating the insurance quote based upon the product information and the product information may include product identification information and/or one or more product features or characteristics, including those discussed elsewhere herein.

The information source associated with the product offeror may include quote requester information. The method may include receiving the quote requester information in response to the quote information request. Generating the insurance quote may include generating the insurance quote based upon the product information and the quote requester information.

The computer-implemented method may include generating an offer for an insurance policy contract based upon the insurance quote, and transmitting the offer for the insurance policy contract to the mobile device. The method may also include receiving via the mobile device an acceptance of the offer for the insurance policy contract, and transmitting an acknowledgement of an issuance of the insurance policy contract to the mobile device.

Receiving the electronic quote request may include optically receiving the quote request information from the proximity information source, such as one of a QR code or an NFC tag. The method may include additional, less, or alternate actions and functionality, including that discussed elsewhere herein.

In another aspect, a computer-implemented method for operating a mobile device may be provided. The method may be performed by a communication device, a graphical user interface, a camera or other sensor, and/or stored application programs executed by a processor on the mobile device. The method may include (1) wirelessly receiving insurance quote request information via a communication link with a proximity information source associated with a product offeror in response to operation of the mobile device by a quote requester; (2) generating and transmitting to an insurance provider address an insurance quote request including the quote request information; (3) receiving an insurance quote in response to the quote request; and/or (4) displaying the insurance quote by a user interface of the mobile device. The insurance quote may be generated by an information system of the insurance provider based upon the quote request information. The quote request information may include the insurance provider address to the information system associated with an insurance provider.

The quote request information may include product information, such as product feature or characteristics mentioned elsewhere herein. Additionally or alternatively, the quote request information may include a product offeror address to an information source associated with the product offeror including quote requester information.

The computer-implemented method may include receiving an insurance policy offer for an insurance policy contract associated with the insurance quote from the insurance provider, and displaying the insurance policy offer by the user interface. The method may also include (1) receiving an acceptance input from the quote requester indicating acceptance of the offer for the insurance policy contract; (2) generating and transmitting to the insurance provider an offer acceptance based upon the acceptance input; (3) receiving an acknowledgement of an issuance of the insurance policy contract by the insurance provider; and/or (4) displaying the acknowledgment by the user interface.

The quote request information may include a product offeror address to an information source associated with the product offeror including one or both of product information or quote requester information.

The computer-implemented method may include receiving an insurance policy offer for an insurance policy contract associated with the insurance quote from the insurance provider, and/or displaying the insurance policy offer by the user interface. The method may also include (1) receiving an acceptance input from the quote requester indicating acceptance of the offer for the insurance policy contract; (2) generating and transmitting to the insurance provider an offer acceptance based upon the acceptance input; (3) receiving an acknowledgement of an issuance of the insurance policy contract by the insurance provider; and/or (4) displaying the acknowledgment by the user interface.

Receiving the insurance quote request information may include optically receiving the insurance quote request information from a QR code. The method may include additional, less, or alternate actions or functionality, including that discussed elsewhere herein.

### Exemplary Product Embodiments

In one aspect, a mobile device for providing an insurance quote for a product using product information embedded or attached to the product may be provided. The mobile device may include one or more processors, transceivers, and cameras. The mobile device may be configured to: (1) capture, image, record, or otherwise determine product information associated with a product that the user desires to obtain insurance coverage for; (2) transmit, via a first wireless communication over one or more radio frequency links, the product information to a remote server; (3) receive, via a second wireless communication over the one or more radio frequency links, from the remote server an insurance quote for insurance covering the product, the insurance quote being based upon the product information; and/or (4) present or display on the mobile device screen the insurance quote for the user's review, modification, or approval to facilitate providing insurance coverage for a product having features detailed by information, codes, or tags attached to the product. The mobile device may be configured to take a photo of a QR code associated with, or attached to, the product via a camera installed on the mobile device; and determine one or more product characteristics or features from the QR code. Additionally or alternatively, the mobile device may be configured to determine one or more product characteristics or features from a near field communication (NFC) tag attached to the product. The mobile device may include additional, less, or alternate functionality, including that discussed elsewhere herein.

In another aspect, a computer-implemented method of providing an insurance quote for a product using product information embedded or attached to the product may be provided. The method may be implemented via a mobile device including one or more processors, transceivers, and cameras. The method may include (1) capturing, imaging, recording, or otherwise determining, via the mobile device, product information associated with a product that the user desires to obtain insurance coverage for; (2) transmitting, via the mobile device and via a first wireless communication over one or more radio frequency links, the product information to a remote server; (3) receiving, via the mobile device and via a second wireless communication over the one or more radio frequency links, from the remote server an insurance quote for insurance covering the product, the insurance quote being based upon the product information; and/or (4) presenting or displaying on the mobile device screen the insurance quote for the user's review, modification, or approval to facilitate providing insurance coverage for a product having features detailed by information, codes, or tags attached to the product. The method may include additional, less, or alternate functionality, including that discussed elsewhere herein.

In another aspect, a mobile device for providing an insurance quote for a product using product information embedded or attached to the product may be provided. The mobile device may include one or more processors, transceivers, and cameras. The mobile device may be configured to: (1) capture, image, or record a QR code or NFC tag associated with a product that the user desires to obtain insurance coverage for; (2) transmit, via a first wireless communication over one or more radio frequency links, the QR code or NFC tag to a remote server; (3) receive from the remote server, via a second wireless communication over the one or more radio frequency links, an insurance quote for insurance covering the product, the insurance quote being based upon product information determined (at the remote server) from, or embedded or encoded within, the QR code or NFC tag; and/or (4) present or display on the mobile device screen the insurance quote for the user's review, modification, or approval to facilitate providing insurance coverage for a product having features detailed by information, codes, or tags attached to the product. The mobile device may be configured to take a photo of a QR code associated with, or attached to, the product via a camera installed on the mobile device; and determine one or more product characteristics or features from the QR code. Additionally or alternatively, the mobile device may be configured to determine one or more product characteristics or features from a near field communication (NFC) tag attached to the product. The mobile device may include additional, less, or alternate functionality, including that discussed elsewhere herein.

As noted above, determining the product information and/or product features or characteristics from a QR code, NFC tag, or RFID tag may be done locally, such as at the mobile device, or remotely, such as at a remote server associated with a vehicle dealership, real estate agent, or insurance provider. After which, the insurance provider may provide an insurance quote based upon the product information and/or product features or characteristics determined from, or associated with, the QR code, NFC tag, or RFID tag.

In another aspect, a computer-implemented method of providing an insurance quote for a product using product information embedded or attached to the product may be provided. The method may be implemented via a mobile device including one or more processors, transceivers, and cameras. The method may include: (1) capturing, imaging, or recording, via the mobile device or a mobile device camera, a QR code or NFC tag associated with a product that the user desires to obtain insurance coverage for; (2) transmitting, via a first wireless communication over one or more radio frequency links, the QR code or NFC tag to a remote server; (3) receiving from the remote server, via a second wireless communication over the one or more radio frequency links, an insurance quote for insurance covering the product, the insurance quote being based upon product information determined from the QR code or NFC tag at the remote server, or embedded or encoded within the QR code or NFC tag; and/or (4) presenting or displaying on the mobile device screen the insurance quote for the user's review, modification, or approval to facilitate providing insurance coverage for a product having features detailed by information, codes, or tags attached to the product. The method may include additional, less, or alternate functionality, including that discussed elsewhere herein.

### Auto Insurance Quote & Vehicle Loan Embodiments

The present embodiments may relate to, inter alia, generating auto insurance quotes and providing auto insurance to customers. The present embodiments may also relate to generating vehicle loan quotes and providing vehicle loans to customers.

In some embodiments, a customer may be shopping for a new or used vehicle at a dealership. A vehicle that the customer is interested in purchasing may have a QR (Quick Response) code or a Near Field Communication (NFC) tag (or other smart tag) attached to, or otherwise associated with, the vehicle. The vehicle QR code or vehicle NFC tag may include information about the vehicle and/or an associated URL (Uniform Resource Locator)(or web address of a web page, or other link associated with the internet). The information about the vehicle may detail features of the vehicle, such as make, model, year, mileage, color, tires, autonomous or semi-autonomous features, smart or advanced safety features, and other vehicle information. The URL or web address may be to a web page that includes similar information about the vehicle and vehicle features.

The customer may scan the vehicle QR code via the camera on their mobile device, or otherwise capture or image the vehicle QR code. Alternatively, the customer may tap the vehicle NFC tag with a NFC-enabled mobile device, or otherwise receive or retrieve the vehicle information and/or URL from the vehicle NFC tag.

The customer's mobile device may then transmit (i) the vehicle QR code; (ii) the vehicle information or a URL determined from the vehicle QR code, and/or (iii) the vehicle information and/or a URL received from the vehicle NFC tag to a (1) vehicle dealership computer; (2) auto insurance provider remote server; and/or (3) vehicle loan provider remote server.

At the vehicle dealership, the customer's mobile device may transmit the QR code to a dealership computer, and the dealership computer may determine the vehicle information from the QR code or URL of a web page detailing the vehicle information. Additionally or alternatively, the customer's mobile device may transmit the vehicle information or URL determined from the QR code or NFC tag to the dealership computer. After which, the vehicle information from the QR code or URL may be used to start the vehicle purchasing process at the dealership. For instance, paperwork at the dealership computer (purchase agreement, title transfer, etc.) may be pre-populated using the vehicle information contained within the QR code or available at the URL, such as make, model, VIN, and other information.

Additionally or alternatively, at the vehicle dealership, the customer may determine a vehicle that they would like to purchase. The customer may verbally identify that vehicle to a salesperson at the dealership. The salesperson may manually enter (e.g., type) the vehicle information into a web page, or access a web page with pre-existing vehicle information. The salesperson may also manually enter customer information, such as name, address, financial information, etc. into the web page. Once the vehicle information and/or customer information has been entered into the dealership computer or web page, the dealership computer may use a QR code generator or the like to generate a QR code.

The QR code generated may include (i) vehicle information or an associated URL of a web page detailing the vehicle information, (ii) customer information or an associated URL of a web page detailing the customer information, and/or (iii) vehicle information and customer information, or an associated URL of a web page detailing both the vehicle and customer information. The QR code generated may be displayed on a computer screen at the dealership. The customer's mobile device may scan (or otherwise capture) the QR code containing the vehicle information and/or customer information, and/or an associated URL. The customer's mobile device may then transmit the QR code generated by a dealership computer (and detailing the vehicle information and/or customer information) to (i) an insurance provider remote server to obtain an auto insurance quote, and/or (ii) an auto loan provider remote server to obtain an auto loan for purchasing the vehicle.

As noted, the customer's mobile device may transmit the QR code; vehicle information determined from (i) the QR code generated by a dealership computer, or (ii) a QR code or NFC tag attached to a vehicle; and/or associated URLs to an insurance provider remote server. In some embodiments, the customer's mobile device may also transmit customer information determined from the QR code generated by the dealership computer, an associated URL, and/or other customer information stored on the customer's mobile device or the dealership computer to the insurance provider remote server. The insurance provider remote server may determine a quote for auto insurance based upon (i) the vehicle information, including vehicle features; (ii) the customer information received; and/or (iii) additional customer information retrieved with the customer's permission. The additional customer information may include customer profile information or other customer information, such as customer information previously gathered and stored for a previous or current customer.

Additionally or alternatively, the customer information may include driving history and/or driving behavior information for the customer and/or customer's household. The driving behavior information may include vehicle telematics data detailing the driving behavior of the customer, such as acceleration, deceleration, braking, distance, speed, heading, route, and cornering information. The vehicle telematics data may also include miles driven, GPS information, location information, routes taken, time-of-day driving, weather information or type of weather the customer typically drives in, congestion information or type of traffic the customer typically drives in, etc. The telematics data may be stored on the customer's mobile device or at an insurance provider remote server.

In some embodiments, the customer's mobile device may only transmit (i) vehicle information (or associated URL or web address) determined from a QR code or NFC tag; or (ii) a QR code (or associated URL or web address) containing the vehicle information. If the customer's mobile device transmits a QR code to the insurance provider remote server, the insurance provider remote server may be configured to determine vehicle information from the QR code received, and/or retrieve vehicle information from a web address or URL detailed or identified by the QR code received. The insurance provider remote server may retrieve customer information or a customer profile for the customer if the customer is a current customer of the insurance provider. Additionally or alternatively, the insurance provider remote server may automatically gather or collect information about the customer with the customer's permission or affirmative consent. Additionally or alternatively, the insurance provider remote server may allow the customer to enter customer information or ask the customer for selective additional customer information, such as the age of those who will be driving the vehicle, where will the vehicle be garaged, and/or the number of drivers for the vehicle.

The insurance provider remote server may generate an auto insurance quote for the vehicle based upon (i) vehicle information determined from the QR code or NFC tag (or an associated URL or web address); (ii) customer information determined from the QR code; (iii) pre-existing customer information; and/or (iv) additional customer information received from the customer, the customer's mobile device, and/or determined from the internet (with the customer's permission). The insurance provider remote server may transmit the insurance quote to the customer's mobile device for the customer's review, modification, and/or approval. For instance, the customer may modify the miles that the vehicle will be driven annually and by who via their mobile device, and/or accept and enter into a binding insurance contract covering the vehicle via their mobile device.

In some embodiments, the insurance provider remote server may pre-populate fields of a web page for requesting an auto insurance quote using (i) the vehicle information determined from the QR code or NFC tag; (ii) customer information received or determined from the QR code or NFC tag; and/or (iii) pre-existing customer information for current customers. The insurance provider remote server may send the web page, or a link thereto, to the customer's mobile device. The customer may access the pre-populated web page; review and modify certain fields; and hit a submit button or icon on the web page to request an auto insurance quote based upon the vehicle information and customer information. After which, the insurance provider remote server may transmit an insurance quote generated based upon the final vehicle and customer information submitted by the customer using their mobile device.

Furthermore, the customer's mobile device may transmit the QR code; vehicle information determined from (i) the QR code generated by a dealership computer, or (ii) a QR code or NFC tag attached to a vehicle; and/or (iii) associated URLs to a vehicle loan provider remote server. In some embodiments, the customer's mobile device may also transmit customer information determined from the QR code generated by the dealership computer, an associated URL, and/or other customer information stored on the customer's mobile device to the vehicle loan provider remote server. The vehicle loan provider remote server may determine a quote and/or terms for an auto loan based upon (i) the vehicle information, including vehicle features; (ii) the customer information received; and/or (iii) additional customer information retrieved with the customer's permission. The additional customer information may include customer profile information or other customer information, such as customer information previously gathered or stored for a current customer. Additionally or alternatively, the customer information may include driving history and/or driving behavior information for the customer and/or customer's household.

In some embodiments, the customer's mobile device may only transmit (i) vehicle information (or an associated URL or web address) determined from a QR code or NFC tag; or (ii) a QR code (or an associated URL or web address) containing the vehicle information. If the customer's mobile device transmits a QR code to the vehicle loan provider remote server, the vehicle loan provider remote server may be configured to determine vehicle information from the QR code received, and/or retrieve vehicle information from a web address or URL detailed or identified by the QR code received. The vehicle loan provider remote server may retrieve customer information or a customer profile for the customer if the customer is a current customer.

Additionally or alternatively, the vehicle loan provider remote server may automatically gather or collect information about the customer with the customer's permission or affirmative consent. Additionally or alternatively, the vehicle loan provider remote server may allow the customer to enter customer information and/or ask the customer for selective customer information, such as financial information, employment information, the age of those who will be driving the vehicle, where will the vehicle be garaged, and/or the number of drivers for the vehicle.

The vehicle loan provider remote server may generate a vehicle loan quote or terms of a vehicle loan based upon (i) vehicle information determined from the QR code or NFC tag (or an associated URL or web address); (ii) customer information determined from the QR code; (iii) pre-existing customer information; and/or (iv) additional customer information received from the customer, the customer's mobile device, or determined from the internet (with the customer's permission). The vehicle loan provider remote server may transmit the vehicle loan quote and/or terms thereof to the customer's mobile device for the customer's review, modification, and/or approval. For instance, the customer may modify the vehicle loan's terms (e.g., down payment amount, length, means of payment, etc.) via their mobile device, and/or accept and enter into the vehicle loan via their mobile device.

### Homeowners Insurance Quote & Home Loan Embodiments

The present embodiments may relate to, inter alia, generating homeowners insurance quotes and providing homeowners insurance to customers. The present embodiments may also relate to generating home loan quotes and providing home loans to customers.

In some embodiments, a customer may be shopping for a new or used home. A home that the customer is interested in purchasing may have a QR (Quick Response) code or a Near Field Communication (NFC) tag (or other smart tag) attached to, or otherwise associated with, the home, such as for potential buyers to scan or tap via their mobile device during an open house. The home QR code or home NFC tag may include information about the home and/or an associated URL (Uniform Resource Locator)(or web address or other link associated with the internet). The information about the home may detail features and characteristics of the home, such as the home features detailed elsewhere herein. The URL or web address may be to a web page that includes similar information about the home and home features.

The customer may scan the home QR code via the camera on their mobile device, or otherwise capture or image the home QR code. Alternatively, the customer may tap the home NFC tag with a NFC-enabled mobile device, or otherwise receive or retrieve the home feature and characteristic information and/or URL from the home NFC tag.

The customer's mobile device may then transmit (i) the home QR code; (ii) the home information or a URL determined from the home QR code; and/or (iii) the home information and/or a URL received from the home NFC tag to a (1) realtor computer; (2) insurance provider remote server; and/or (3) home loan provider remote server.

The customer's mobile device may transmit the QR code to a realtor computer, and the realtor computer may determine the home information from the QR code or URL detailing the home information. Additionally or alternatively, the customer's mobile device may transmit the home information or URL determined from the QR code or NFC tag to the realtor computer. After which, the home information from the QR code or URL may be used to start the process of generating an offer for the home at the realtor. For instance, paperwork at the realtor computer (purchase agreement, title transfer, etc.) may be pre-populated using the home information contained within the QR code or available at the URL.

Additionally or alternatively, the customer may determine a home that they would like to purchase. The customer may verbally identify that home to a realtor. The realtor may manually enter (e.g., type) the home information into a web page, or access a web page with pre-existing information for the home. The realtor may also manually enter customer information, such as name, address, financial information, etc. into the web page. Once the home information and/or customer information has been entered into the realtor computer or web page, the realtor computer may use a QR code generator or the like to generate a QR code.

The QR code generated may include (i) home information or an associated URL, (ii) customer information or an associated URL, and/or (iii) home information and customer information, and/or an associated URL. The QR code generated may be displayed on a computer screen at the realtor or on a realtor mobile device. The customer's mobile device may scan (or otherwise capture) the QR code containing the home information and/or customer information, and/or an associated URL. The customer's mobile device may then transmit the QR code generated by a realtor computer or mobile device (and detailing the home information and/or customer information) to (i) an insurance provider remote server to obtain a homeowners insurance quote, and/or (ii) a home loan provider remote server to obtain a home loan for purchasing the home.

As noted, the customer's mobile device may transmit the QR code, home information determined from the QR code generated by a realtor computer or a QR code or NFC tag attached to a home, or associated URLs to an insurance provider remote server. In some embodiments, the customer's mobile device may also transmit customer information determined from the QR code generated by the realtor computer, an associated URL, and/or other customer information stored on the customer's mobile device to the insurance provider remote server. The insurance provider remote server may determine a quote for homeowners insurance based upon (i) the home information, including home features and characteristics, such as those discussed elsewhere herein; (ii) the customer information received; and/or (iii) additional customer information retrieved with the customer's permission. The additional customer information may include customer profile information or other customer information, such as customer information previously gathered for a current customer. Additionally or alternatively, the customer information may include financial and employment information.

In some embodiments, the customer's mobile device may only transmit (i) home information (or an associated URL or web address) determined from a QR code or NFC tag; or (ii) a QR code (or an associated URL or web address of a web page) containing the home information. If the customer's mobile device transmits a QR code to the insurance provider remote server, the insurance provider remote server may be configured to determine home information from the QR code received, and/or retrieve home information from a web address or URL detailed or identified by the QR code received. The insurance provider remote server may retrieve customer information or a customer profile for the customer if the customer is a current customer of the insurance provider. Additionally or alternatively, the insurance provider remote server may automatically gather or collect information about the customer with the customer's permission or affirmative consent. Additionally or alternatively, the insurance provider remote server may allow the customer to enter customer information and/or ask the customer for selective customer information.

The insurance provider remote server may generate a homeowners insurance quote for the home based upon (i) home information determined from the QR code or NFC tag (or an associated URL or web address); (ii) customer information determined from the QR code; (iii) pre-existing customer information; and/or (iv) additional customer information received from the customer, the customer's mobile device, or determined from the internet (with the customer's permission). The insurance provider remote server may transmit the insurance quote to the customer's mobile device for the customer's review, modification, and/or approval. For instance, the customer may modify coverages, deductibles, and/or limits for the homeowners insurance via their mobile device, and/or accept and enter into an insurance contract covering the home via their mobile device.

In some embodiments, the insurance provider remote server may pre-populate fields of a web page for requesting a homeowners insurance quote using (i) the home information determined from the QR code or NFC tag; (ii) customer information received or determined from the QR code or NFC tag; and/or (iii) pre-existing customer information for current customers. The insurance provider remote server may send the web page, or a link thereto, to the customer's mobile device. The customer may access the pre-populated web page; review and modify certain fields; and hit a submit button or icon on the web page to request a homeowners insurance quote based upon the home information and customer information. After which, the insurance provider remote server may transmit an insurance quote generated based upon the final home and customer information submitted by the customer using their mobile device.

Furthermore, the customer's mobile device may transmit the QR code, home information determined from the QR code generated by a realtor computer or a QR code or NFC tag attached to a home, or associated URLs to a home loan provider remote server. In some embodiments, the customer's mobile device may also transmit customer information determined from the QR code generated by the realtor computer, an associated URL, and/or other customer information stored on the customer's mobile device to the home loan provider remote server. The home loan provider remote server may determine a quote or terms for a home loan based upon (i) the home information, including home features and characteristics; (ii) the customer information received; and/or (iii) additional customer information retrieved with the customer's permission. The additional customer information may include customer profile information or other customer information, such as customer information previously gathered for a current customer.

In some embodiments, the customer's mobile device may only transmit (i) home information (or an associated URL or web address) determined from a QR code or NFC tag; or (ii) a QR code (or an associated URL or web address of a web page) containing the home information. If the customer's mobile device transmits a QR code to the home loan provider remote server, the home loan provider remote server may be configured to determine home information from the QR code received, and/or retrieve home information from a web address or URL detailed or identified by the QR code received. The home loan provider remote server may retrieve customer information or a customer profile for the customer if the customer is a current customer. Additionally or alternatively, the home loan provider remote server may automatically gather or collect information about the customer with the customer's permission or affirmative consent. Additionally or alternatively, the home loan provider remote server may allow the customer to enter customer information or ask the customer for selective customer information, such as financial and employment information.

The home loan provider remote server may generate a home loan quote or terms of the home loan based upon (i) home information determined from the QR code or NFC tag (or an associated URL or web address); (ii) customer information determined from the QR code; (iii) pre-existing customer information; and/or (iv) additional customer information received from the customer, the customer's mobile device, or determined from the internet (with the customer's permission). The home loan provider remote server may transmit the home loan quote to the customer's mobile device for the customer's review, modification, and/or approval. For instance, the customer may modify the home loan's terms (e.g., length, amount of down payment, payment method, etc.) via their mobile device, and/or accept and enter into the home loan via their mobile device.

In one aspect, a computer-implemented method of generating a QR (Quick Response) code detailing vehicle or home feature and characteristic information may be provided. The method may include (1) receiving, via one or more processors and/or associated transceivers, an identification of a vehicle or home selected by a user; (2) determining or identifying, via the one or more processors, characteristic data of the vehicle or home selected by the user; (3) receiving or generating, via the one or more processors and/or associated transceivers, customer data associated with the user; and/or (4) generating, via the one or more processors, a QR code that encodes (a) the (i) characteristic data of the vehicle or home selected by the user, and (ii) customer data associated with the user; or (b) a web address of a web page that includes the (i) characteristic data of the vehicle or home selected by the user, and (ii) customer data associated with the user. The computer-implemented method may include additional, less, or alternate actions, including those discussed elsewhere herein.

For instance, the computer-implemented method may include presenting, via the one or more processors, the QR code on a display screen to allow the QR code to be scanned by a mobile device. The method may also include (i) transmitting, via the mobile device, the QR code to an insurance provider remote server; (ii) receiving, via the mobile device, an auto insurance quote for the vehicle that is based upon vehicle features encoded within the QR code from the insurance provider remote server; and/or (iii) presenting, via the mobile device, the auto insurance quote. Additionally or alternatively, the method may include (i) transmitting, via the mobile device, the QR code to an insurance provider remote server; (ii) receiving, via the mobile device, a homeowners insurance quote for the home that is based upon home features encoded within the QR code from the insurance provider remote server; and/or (iii) presenting or displaying, via the mobile device, the homeowners insurance quote.

Additionally or alternatively, the computer-implemented method may include (i) transmitting, via the mobile device, the QR code to a home loan provider remote server; (ii) receiving, via the mobile device, home loan terms for the home that are based upon the home features encoded within the QR code from the home loan provider remote server; and/or (iii) presenting, via the mobile device, the home loan terms. Additionally or alternatively, the method may include (i) transmitting, via the mobile device, the QR code to a vehicle loan provider remote server; (ii) receiving, via the mobile device, vehicle loan terms for the vehicle that are based upon the vehicle features encoded within the QR code from the vehicle loan provider remote server; and/or (iii) presenting, via the mobile device, the vehicle loan terms.

The computer-implemented method may include (i) transmitting, via the one or more processors and/or associated transceivers, the QR code to an insurance provider remote server; (ii) receiving, via the one or more processors and/or associated transceivers, an auto insurance quote for the vehicle that is based upon vehicle features encoded within the QR code from the insurance provider remote server; and/or (iii) presenting or displaying, via the one or more processors, the auto insurance quote. Additionally or alternatively, the method may include (i) transmitting, via the one or more processors and/or associated transceivers, the QR code to an insurance provider remote server; (ii) receiving, via the one or more processors and/or associated transceivers, a homeowners insurance quote for the home that is based upon home features encoded within the QR code from the insurance provider remote server; and/or (iii) presenting, via the one or more processors, the homeowners insurance quote.

The computer-implemented method may include (i) transmitting, via the one or more processors and/or associated transceivers, the QR code to a home loan provider remote server; (ii) receiving, via the one or more processors and/or associated transceivers, home loan terms for the home that are based upon the home features encoded within the QR code from the home loan provider remote server; and/or (iii) presenting, via the one or more processors, the home loan terms. Additionally or alternatively, the method may include (i) transmitting, via the one or more processors and/or associated transceivers, the QR code to a vehicle loan provider remote server; (ii) receiving, via the one or more processors and/or associated transceivers, vehicle loan terms for the vehicle that are based upon the vehicle features encoded within the QR code from the vehicle loan provider remote server; and/or (iii) presenting, via the one or more processors, the vehicle loan terms.

In another aspect, a computer-implemented method of scanning vehicle or home feature and characteristic information via a mobile device may be provided. The method may include (1) scanning, via one or more processors and/or an associated camera, a QR (Quick Response) code, the QR code detailing (i) vehicle or house characteristic data, or (ii) a web address of a web page detailing the vehicle or house characteristic data; (2) transmitting, via the one or more processors and/or associated transceivers, the QR code, the vehicle or house characteristic data, or the web address of the web page detailing the vehicle or house characteristic data to a remote server; and/or (3) receiving, via the one or more processors and/or associated transceivers, an insurance quote for insurance covering the vehicle or house from the remote server, the insurance quote being generated, at least in part, based on the vehicle or house characteristic data determined from the QR code, respectively.

The computer-implemented method may also include transmitting, via the one or more processors and/or associated transceivers, customer information to the remote server, and the insurance quote may be further generated based on the customer information. The QR code may detail (i) vehicle characteristic data; (ii) customer data; and/or (iii) a web address of a web page detailing the vehicle characteristic data and/or customer data. Alternatively, the QR code may detail (i) house characteristic data; (ii) customer data; and/or (iii) a web address of a web page detailing the house characteristic data and/or customer data.

The computer-implemented method may also include (i) transmitting, via the one or more processors and/or associated transceivers, the QR code, the vehicle or house characteristic data, the customer data, and/or the web address of a web page detailing the vehicle or house characteristic data and/or customer data to a second remote server; and/or (ii) receiving, via the one or more processors and/or associated transceivers, loan terms for a vehicle or home loan from the second remote server, the loan terms being generated, at least in part, based on the vehicle or house characteristic data determined from the QR code, respectively, and the customer data. The computer-implemented method may include additional, less, or alternate functionality and actions, including those discussed elsewhere herein.

### Computer-Implemented Methods Utilizing QR Codes & NFC Tags

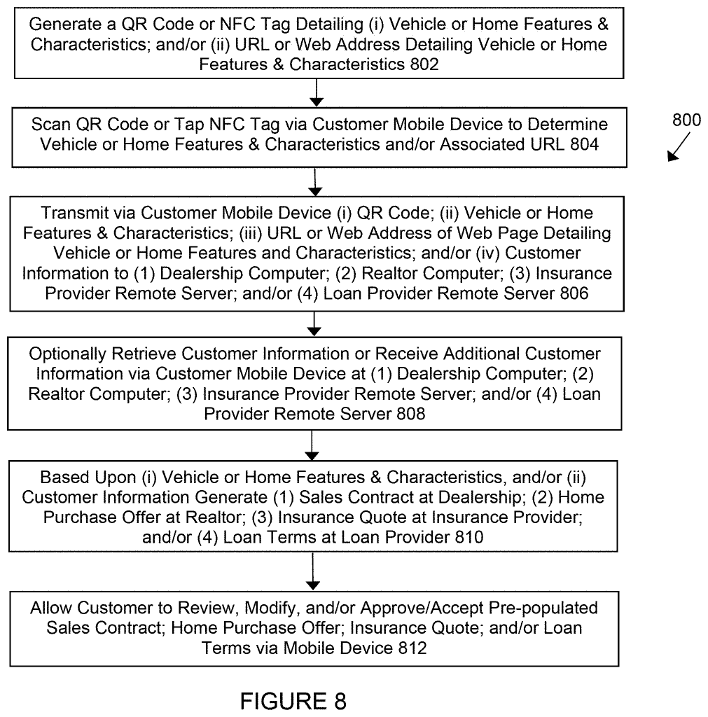

FIG. 8 illustrates an exemplary computer-implemented method of providing sales contracts, insurance quotes, and/or loans for vehicle and homes using QR codes and/or NFC tags 800. The computer-implemented method 800 may be implemented via one or more local or remote processors, transceivers, memory units, sensors, cameras, servers, mobile devices, wearables, laptops, desktops, and/or other computer devices.

The computer-implemented method 800 may include, via one or more local or remote processors, generating a QR code or NFC tag detailing (i) vehicle or home features and characteristics; and/or (ii) an associated URL or web address of a web page detailing or listing the vehicle or home features and characteristics 802. The QR code or NFC tag may be attached to, or otherwise associated with, a vehicle or home being offered for sale.

The vehicle features and characteristics included within a QR code or NFC tag, or located at a web address, may include information about the vehicle, such as for example its vehicle ID (VIN), make, model, age, mileage, price, advanced safety features, autonomous or semi-autonomous features or systems, and/or condition, and/or information such as addresses or locations of other sources of information about the vehicles. The types of autonomous or semi-autonomous vehicle-related functionality or technology information about the vehicle may include or indicate that the vehicle has the following functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; (j) adaptive cruise control; (k) automatic or semi-automatic parking/parking assistance; (1) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; (s) automatic or semi-automatic driving without occupants; and/or other functionality.

The home features and characteristics detailed within a QR code or NFC tag, or listed at a web address of a web page, may include information about the home, such as its size, construction type, location, age, square footage, number of floors, number of bedrooms and bathrooms, type of roofing, smart home or intelligent home functionality and sensors, type of materials, size and number of windows, type of flooring and cabinets, size of lot, and other information about the home, including that mentioned elsewhere herein.

The computer-implemented method 800 may include a customer, via one or more processors on the customer's mobile device, scanning a QR code via a camera on the customer's mobile device or tapping a NFC tag (or other smart tag) via the customer's mobile device 804. The customer's mobile device may be configured to determine vehicle or home features and characteristics detailed or encoded within the QR code, or a URL or web address detailed or encoded within QR code or NFC tag.

The computer-implemented method 800 may include transmitting, via one or more processors and/or associated transceivers on the customer's mobile device and via wireless communication and data transmission over one or more radio frequency links, (i) a QR code; (ii) the vehicle or home features and characteristics; (iii) a URL or web address of a web page detailing the vehicle or home features and characteristics; and/or (iv) customer information to (1) a dealership mobile device, computer, or server; (2) a realtor mobile device, computer, or server; (3) an insurance provider remote server; and/or (4) a loan provider remote server 806.

The computer-implemented method 800 may optionally include retrieving, one or more local or remote processors and/or transceivers, customer information and/or receive, such as via wireless communication and data transmission over one or more radio frequency links, additional customer information transmitted by the customer's mobile device at (1) the dealership mobile device, computer, or server; (2) the realtor mobile device, computer, or server; (3) the insurance provider remote server; and/or (4) the loan provider remote server 808. For instance, the insurance provider remote server may already have customer information stored in memory unit or a customer profile built for the customer if the customer is a pre-existing or current customer. The remote server may retrieve the pre-existing customer information from the memory unit. Additionally or alternatively, the remote server may need additional customer information to complete an insurance quote, and if so, may transmit a request for additional customer information to the customer's mobile device, and the customer may provide the additional information via their mobile device.

The computer-implemented method 800 may include generating, via one or more local or more processors, transceivers, and/or servers, (1) a vehicle sales contract; (2) a home purchase offer; (3) an insurance quote; and/or (4) loan terms based upon (i) the vehicle or home features or characteristics, and/or (ii) customer information 810. For instance, based upon the vehicle and customer information, a dealership computer may generate a vehicle sales contract. Based upon the home and customer information, a realtor computer may generate an offer to purchase a home for submission to the home owner. Based upon the vehicle or home information and customer information, the insurance provider remote server may generate a vehicle insurance quote or homeowners insurance quote, respectively. Based upon the vehicle or home information and customer information, the loan provider remote server may generate vehicle or home loan terms, respectively.

The computer-implemented method 800 may include allowing the customer to review, modify, and/or approve a pre-populated vehicle sales contract, a pre-populated offer to purchase a home, a pre-populated auto or homeowners insurance quote; and/or a pre-populated loan offer via the customer's mobile device 812. For instance, fields within an insurance quote page may be pre-populated with information taken from (a) the vehicle or home features and characteristics received, and/or (b) the customer information received or retrieved. The customer may be able to fill in empty fields or change pre-filled fields in the insurance quote page prior to final submission via the customer's mobile device, and then receive the quote via their mobile device. The customer may approve or accept a sales contract, purchase offer, insurance quote, or loan terms via their mobile device and wireless communication. The computer-implemented method 800 may include additional, less, or alternate functionality or actions, including those discussed elsewhere herein.

### Exemplary Qr Code Generation

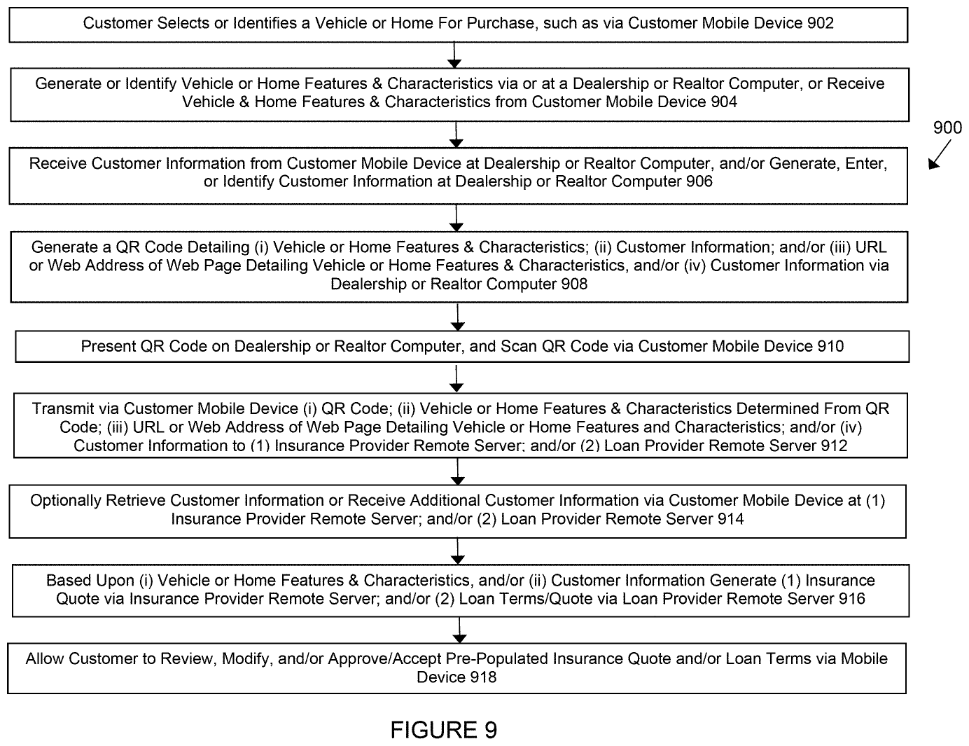

FIG. 9 illustrates an exemplary computer-implemented method of providing insurance quotes and/or loan terms for vehicle and homes using QR codes generated at vehicle dealerships or realtor locations, respectively 900. The computer-implemented method 900 may be implemented via one or more local or remote processors, transceivers, memory units, sensors, cameras, servers, mobile devices, wearables, laptops, desktops, and/or other computer devices.

The computer-implemented method 900 may include the customer selecting or identifying a vehicle or home for purchase 902. The method 900 may include the customer selecting, via one or more processors, a vehicle or home for purchase. For instance, the customer may view vehicle or home listings posted on the internet via their mobile device, and select one that they want to purchase using their mobile device. The customer mobile device may collect or gather vehicle or home features and characteristics associated with the selected vehicle or home, respectively, and may store the vehicle or home features and characteristics in a memory unit and/or transmit the vehicle and home features and characteristics to another computing device, such as a dealership computer or realtor computer.

The computer-implemented method 900 may include generating or identifying, via one or more local or remote processors, vehicle or home features and characteristics 904. For instance, once a vehicle or home is selected by the customer for purchase, a dealership or realtor computer may determine or retrieve vehicle or home features and characteristics for the selected vehicle or home, respectively. Additionally or alternatively, the method 900 may include receiving, via one or more processors and/or associated transceivers of a dealership or realtor computer, vehicle or home features and characteristics transmitted via the customer's mobile device over one or more radio frequency links using wireless communication and data transmission.

The computer-implemented method 900 may include receiving customer information transmitted from the customer mobile device at the dealership or realtor computer, or otherwise generating or entering customer information at the dealership or realtor computer 906. For instance, one or more processors and/or associated transceivers of the customer mobile device may transmit certain customer information to a transceiver associated with the dealership or realtor computer over one or more radio frequency links using wireless communication and/or data transmission. Additionally or alternatively, a salesperson or realtor may manually enter customer information provided verbally by the customer into the dealership or realtor computer.

The computer-implemented method 900 may include generating a QR code detailing (i) vehicle or home features and characteristics; (ii) customer information; and/or (iii) a URL or web address of a web page detailing the vehicle or home features and characteristics, and/or customer information via the dealership or realtor computer 908. In some embodiments, the QR code may detail both (a) the vehicle or home features/characteristics, and (b) customer information, or provide a web address to web page listing both. This may provide an efficient manner of gathering or collecting the requisite information needed to generate insurance quotes and/or loan terms.

The computer-implemented method 900 may include presenting the QR code on the dealership or realtor computer display screen, and the customer scanning the QR code via their mobile device 910, such as via a camera on the customer mobile device. In some embodiments, the QR generated may be displayed on a salesperson's mobile device or a realtor's mobile device from which the customer may scan using their mobile device.

The computer-implemented method 900 may include transmitting, via one or more local or remote processors and/or associated transceivers, (i) the QR code; (ii) the vehicle or home features or characteristics determined from the QR code; (iii) a URL or web address of a web page detailing the vehicle or home features and characteristics; and/or (iv) customer information to (1) an insurance provider remote server, and/or (2) a loan provider remote server 912. For instance, the one or more local or remote processors and/or associated transceivers may be associated with, or part of, the customer's mobile device, a salesperson's mobile device, a realtor's mobile device, the dealership computer, and/or the realtor computer.

The computer-implemented method 900 may include optionally retrieving, via one or more local or remote processors and/or associated transceivers, customer information stored in a local or remote memory unit or located on the internet 914. For instance, for pre-existing or current customers, an insurance or loan provider remote server may access pre-existing customer information stored in a memory unit or customer profile, and may access customer information located at one or more websites with the customer's permission or affirmative consent.

Additionally or alternatively, the method may include receiving additional customer information transmitted from the customer's mobile device via wireless communication and data transmission at the insurance provider remote server or loan provider remote server. For instance, the insurance or loan provider remote server may query the customer for additional personal information via the customer's mobile device.

The computer-implemented method 900 may include, via one or more local or remote processors and/or associated transceivers, generating an insurance quote or loan terms based upon (i) the vehicle or home features and characteristics, and/or (ii) the customer information 916. For instance, an auto insurance or homeowners insurance quote may be generated via an insurance provider remote server, or vehicle or home loan terms may be generated via a loan provider remote server. The insurance quote or loan terms may then be transmitted to the customer's mobile device for their review, modification, and/or approval.

In some embodiments, the computer-implemented method 900 may include allowing the customer to review, modify, and/or approve a pre-populated auto or homeowners insurance quote, and/or a pre-populated vehicle or home loan via the customer mobile device 918. For instance, certain fields of an auto insurance quote page may be pre-populated with vehicle or home feature information and/or customer information received by the insurance provider remote server. The customer may then edit or change certain field information, and submit a final version to receive an insurance quote. Additionally or alternatively, an insurance quote may be provided to the customer based upon the vehicle or home information, and customer information, received or retrieved without further customer input. The customer may be able to approve the insurance quote via their mobile device, and enter into a binding contract. The computer-implemented method may include additional, less, or alternate functionality or actions, including those discussed elsewhere herein.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are examples only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are examples only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

In some embodiments, registration of users for the customer support platform includes opt-in informed consent of users to data usage by the smart home devices, wearable devices, mobile devices, autonomous vehicles, and/or smart vehicles consistent with consumer protection laws and privacy regulations. In some embodiments, the user data, and/or other collected data may be anonymized and/or aggregated prior to receipt such that no personally identifiable information (PII) is received. In other embodiments, the system may be configured to receive user data and/or other collected data that is not yet anonymized and/or aggregated, and thus may be configured to anonymize and aggregate the data. In such embodiments, any PII received by the system is received and processed in an encrypted format, or is received with the consent of the individual with which the PII is associated. In situations in which the systems discussed herein collect personal information about individuals, or may make use of such personal information, the individuals may be provided with an opportunity to control whether such information is collected or to control whether and/or how such information is used. In addition, certain data may be processed in one or more ways before it is stored or used, so that personally identifiable information is removed.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations or steps, one or more of the individual operations or steps may be performed concurrently, and nothing requires that the operations or steps be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules.

In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules. Moreover, the systems and methods described herein are directed to an improvement to computer functionality and improve the functioning of conventional computers.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for a system and a method as disclosed by the principles herein. Thus, while particular embodiments and applications have been illustrated and described, it is to be understood that the disclosed embodiments are not limited tothe precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method of generating a QR (Quick Response) code detailing vehicle or home feature and characteristic information, the method comprising:
receiving, via one or more processors and/or associated transceivers, an identification of a vehicle or home selected by a user;
determining or identifying, via the one or more processors, characteristic data of the vehicle or home selected by the user;
receiving or generating, via the one or more processors and/or associated transceivers, customer data associated with the user; and
generating, via the one or more processors, a QR code that encodes (a) the (i) characteristic data of the vehicle or home selected by the user, and (ii) customer data associated with the user; or (b) a web address of a web page that includes the (i) characteristic data of the vehicle or home selected by the user, and (ii) customer data associated with the user.

2. The computer-implemented method of claim 1, the method further comprising:
presenting, via the one or more processors, the QR code on a display screen to allow the QR code to be scanned by a mobile device.

3. The computer-implemented method of claim 2, the method comprising:
transmitting, via the mobile device, the QR code to an insurance provider remote server;
receiving, via the mobile device, an auto insurance quote for the vehicle that is based upon vehicle features encoded within the QR code from the insurance provider remote server; and
presenting, via the mobile device, the auto insurance quote.

4. The computer-implemented method of claim 2, the method comprising:
transmitting, via the mobile device, the QR code to an insurance provider remote server;
receiving, via the mobile device, a homeowners insurance quote for the home that is based upon home features encoded within the QR code from the insurance provider remote server; and
presenting or displaying, via the mobile device, the homeowners insurance quote.

5. The computer-implemented method of claim 2, the method comprising:
transmitting, via the mobile device, the QR code to a home loan provider remote server;
receiving, via the mobile device, home loan terms for the home that are based upon the home features encoded within the QR code from the home loan provider remote server; and
presenting, via the mobile device, the home loan terms.

6. The computer-implemented method of claim 2, the method comprising:
transmitting, via the mobile device, the QR code to a vehicle loan provider remote server;
receiving, via the mobile device, vehicle loan terms for the vehicle that are based upon the vehicle features encoded within the QR code from the vehicle loan provider remote server; and
presenting, via the mobile device, the vehicle loan terms.

7. The computer-implemented method of claim 1, the method comprising:
transmitting, via the one or more processors and/or associated transceivers, the QR code to an insurance provider remote server;
receiving, via the one or more processors and/or associated transceivers, an auto insurance quote for the vehicle that is based upon vehicle features encoded within the QR code from the insurance provider remote server; and
presenting or displaying, via the one or more processors, the auto insurance quote.

8. The computer-implemented method of claim 1, the method comprising:
transmitting, via the one or more processors and/or associated transceivers, the QR code to an insurance provider remote server;
receiving, via the one or more processors and/or associated transceivers, a homeowners insurance quote for the home that is based upon home features encoded within the QR code from the insurance provider remote server; and
presenting, via the one or more processors, the homeowners insurance quote.

9. The computer-implemented method of claim 1, the method comprising:
transmitting, via the one or more processors and/or associated transceivers, the QR code to a home loan provider remote server;
receiving, via the one or more processors and/or associated transceivers, home loan terms for the home that are based upon the home features encoded within the QR code from the home loan provider remote server; and
presenting, via the one or more processors, the home loan terms.

10. The computer-implemented method of claim 1, the method comprising:
transmitting, via the one or more processors and/or associated transceivers, the QR code to a vehicle loan provider remote server;
receiving, via the one or more processors and/or associated transceivers, vehicle loan terms for the vehicle that are based upon the vehicle features encoded within the QR code from the vehicle loan provider remote server; and
presenting, via the one or more processors, the vehicle loan terms.

11. A computer-implemented method of scanning vehicle or home feature and characteristic information via a mobile device, the method comprising:
scanning, via one or more processors and/or an associated camera, a QR (Quick Response) code, the QR code detailing (i) vehicle or house characteristic data, or (ii) a web address of a web page detailing the vehicle or house characteristic data;
transmitting, via the one or more processors and/or associated transceivers, the QR code, the vehicle or house characteristic data, or the web address of the web page detailing the vehicle or house characteristic data to a remote server; and
receiving, via the one or more processors and/or associated transceivers, an insurance quote for insurance covering the vehicle or house from the remote server, the insurance quote being generated, at least in part, based on the vehicle or house characteristic data determined from the QR code, respectively.

12. The computer-implemented method of claim 11, the method further comprising:
transmitting, via the one or more processors and/or associated transceivers, customer information to the remote server, wherein the insurance quote is further generated based on the customer information.

13. The computer-implemented method of claim 12, wherein the QR code details vehicle characteristic data.

14. The computer-implemented method of claim 12, wherein the QR code details a web address of a web page detailing the vehicle characteristic data.

15. The computer-implemented method of claim 12, wherein the QR code details house characteristic data.

16. The computer-implemented method of claim 12, wherein the QR code details a web address of a web page detailing the house characteristic data.

17. The computer-implemented method of claim 11, the method further comprising:
transmitting, via the one or more processors and/or associated transceivers, the QR code, the vehicle characteristic data, or the web address of a web page detailing the vehicle characteristic data to a second remote server; and
receiving, via the one or more processors and/or associated transceivers, loan terms for a vehicle loan from the second remote server, the loan terms being generated, at least in part, based on the vehicle characteristic data determined from the QR code.

18. The computer-implemented method of claim 11, the method further comprising:
transmitting, via the one or more processors and/or associated transceivers, the QR code, the house characteristic data, or the web address of a web page detailing the house characteristic data to a second remote server; and
receiving, via the one or more processors and/or associated transceivers, loan terms for a home loan from the second remote server, the loan terms being generated, at least in part, based on the house characteristic data determined from the QR code, respectively.
